(19) United States
(12) Patent Application Publication
(10) Pub. No.: US 2018/0025423 A1
(43) Pub. Date: Jan. 25, 2018

(54) POWER TRANSACTION MANAGEMENT SYSTEM AND POWER TRANSACTION MANAGEMENT METHOD

(71) Applicant: HITACHI, LTD., Tokyo (JP)

(72) Inventors: Masato UTSUMI, Tokyo (JP); Tohru WATANABE, Tokyo (JP); Yoshihisa OKAMOTO, Tokyo (JP); Masao TSUYUZAKI, Tokyo (JP)

(73) Assignee: HITACHI, LTD., Tokyo (JP)

(21) Appl. No.: 15/543,038

(22) PCT Filed: Mar. 10, 2016
(86) PCT No.: PCT/IB2016/051349

§ 371 Date: Jul. 12, 2017

(30) Foreign Application Priority Data
Jan. 15, 2015 (JP) 2015-006129

(51) Int. Cl. G06Q 40/04; H02J 3/00; G06Q 50/06

(52) U.S. Cl. CPC G06Q 40/04; G06Q 50/06; H02J 3/00; H02J 2003/003

(57) ABSTRACT

A system for distributing electric energy on a power trading market, takes into account fluctuating adjustment capacity for power consumption among a plurality of customers. This power trading management system: performs a forecast in power prices; extracts information about a predetermined power product to be traded; adjusts a capacity forecast in the power consumption adjustment capacity which indicates the capacity to adjust power consumption is forecasted for each customer; prepares an adjustment plan by assigning electric energy to be traded to each customer on the basis of capacity to adjust power consumption; prepares a trading plan for the trading of power products on the basis of the adjustment plan; processes order information based on the trading plan and transmits the order information to a market operation management device; and transmits the adjustment plan to each customer.

### TECHNICAL FIELD

This invention relates to a power transaction management system and a power transaction management method.

### BACKGROUND ART

Hitherto, the power demand and the power supply have been balanced by increasing the power supply as the power demand increases. Meanwhile, in recent years, a system in which the power demand and the power supply are balanced by reducing the power demand of consumers has been proposed. The power supplier side obtains surplus power corresponding to the amount of adjustment power when the consumers reduce the power demand. In some cases, the adjustment power is called “negawatt” or the like.

When small consumers trade their adjustment power in the market, the establishment of the transaction is time-consuming. Thus, a power trader called an aggregator groups together the adjustment power of small consumers and sells the adjustment power to the wholesale market.

The related art of power transaction is known (PTL 1), which is however not aimed at grouping together power adjustable by consumers for power transaction in the market. In the related art described in this literature, a power price is forecasted on the basis of weather data of the past, free capacity of interconnected lines, a demand forecast, and the like. Then, bid data in which the power amount to be bid and a bid price are paired is generated to bid for the power transaction market.

### CITATION LIST

### Patent Literature

[PTL 1]
Japanese Patent Application Publication No. 2006-172246

### SUMMARY OF INVENTION

### Technical Problem

The related art is not intended to manage power that is adjustable by small consumers and grouped together, but is intended to manage a power generator of which power generation amount can be controlled to any value. Therefore, there is no need to consider temporal fluctuation in the power amount to be bid. In the related art, the aim is to appropriately sell power that is generated by the power generator, and there is no need to consider a situation in which the power generation amount of the power generator greatly fluctuates.

On the other hand, when the power amount adjusted by a plurality of consumers is grouped together to be purchased and sold in the market, the tradable power amount may fluctuate because each of the consumers may be in a different situation. Therefore, when the power amount adjusted by the plurality of consumers is grouped together to be traded in the market, there is room for improvement in terms of transaction reliability and usability.

This invention has been made in view of the above-mentioned problem, and it is an object of this invention to provide a power transaction management system and a power transaction management method in which the power amount is tradable in a power transaction market in consideration of a fluctuation in ability to adjust the power consumption amount among a plurality of consumers.

### Solution to Problem

In order to solve the problem described above, a power transaction management system according to this invention manages a power transaction and includes: a communication unit communicatively coupled to a market operation management apparatus configured to manage a predetermined power transaction market, and to a plurality of consumers; a memory unit configured to store a predetermined computer program; a processing unit coupled to the communication unit and the memory unit, and configured to execute the predetermined computer program thereby executing predetermined processing, wherein the processing unit is configured to execute: power price forecasting processing of forecasting a future power price in the predetermined power transaction market; power product extracting processing of extracting information on a predetermined power product to be purchased and sold in the predetermined power transaction market on the basis of a predetermined power product extracting condition configured in advance and the forecasted power price; adjusting ability forecasting processing of forecasting, for each of the consumers, a power consumption amount adjusting ability indicating an ability to adjust a power consumption amount at a predetermined time point of transaction of the predetermined power product; adjustment plan crafting processing of crafting an adjustment plan by allocating a power amount to be traded of the predetermined power product to the each of the consumers on the basis of the power consumption amount adjusting ability; transaction plan crafting processing of crafting a transaction plan for purchasing and selling the predetermined power product in the predetermined power transaction market on the basis of the adjustment plan; ordering processing for sending order information based on the transaction plan to the market operation management apparatus; and adjustment plan sending processing of sending the adjustment plan to the each of the consumers.

### Advantageous Effects of Invention

According to this invention, an adjustment plan can be crafted by allocating a power amount to be traded to each of consumers on the basis of the power consumption amount adjusting ability forecasted for each of the consumers, and a transaction plan can be crafted on the basis of the adjustment plan to place an order. Therefore, the power amount can be traded while considering in advance a temporal fluctuation in power consumption amount adjustable by each of the consumers.

### BRIEF DESCRIPTION OF DRAWINGS

FIG. 1 is an explanatory diagram for illustrating the whole concept of a power transaction management system.

FIG. 2 is a configuration diagram of the whole system including the Power transaction management system.

FIG. 3 is an explanatory diagram for illustrating a relationship between a flow of processing and functions of the power transaction management system.

FIG. 4 is an explanatory diagram for illustrating a relationship between hardware and the functions of the power transaction management system.

FIG. 5 is a configuration example of transaction plan information.

FIG. 6 is a configuration example of adjustment plan information.

FIG. 7 is an example of the adjustment plan information shown in a graph.

FIG. 8 is a configuration example of resource specification information.

FIG. 9 is a configuration example of operation constraint information.

FIG. 10 is a flowchart of power transaction plan crafting processing.

FIG. 11 is a flowchart of adjusting ability forecasting processing.

FIG. 12 is a flowchart of adjustment plan crafting processing.

FIG. 13 is a flowchart of transaction plan modifying processing.

FIG. 14 is a flowchart of learning processing.

### DESCRIPTION OF EMBODIMENTS

Embodiments of this invention are described with reference to the drawings. A power trader may contribute to the balancing of the power demand and the power supply not only when the supply and demand of the power grid is tight but also when a wholesale power transaction price increases. For example, the peak of the power demand can be shifted by temporarily reducing the power demand of a group of consumers in a time frame in which the wholesale power price is increased, and then covering the power demand of the group of consumers with use of power procured from other time frames.

For example, the power trader secures power, which is to be supplied to a load equipment, from the power transaction market or a power producer (grid operator) in advance. The load equipment may be hereinafter referred to as an equipment. The power trader sells a part of the secured power in a time period (peak time period) in which the wholesale power price is high through the power transaction market. The power amount that is sold to the power transaction market is the power amount that needs to be reduced and adjusted by the group of consumers. The power amount that needs to be reduced by the group of consumers may be hereinafter referred to as an adjustment power amount.

Each of the consumers can reduce power consumption without effort by actively consuming power at a time point before the peak time period in which power is reduced and adjusted. For example, in seasons when the outside air temperature is low, the consumer may overheat a room in advance, to thereby raise the room temperature. As a result, the room temperature can be prevented from abruptly declining even when heating is stopped during the peak time period. Similarly, in seasons when the outside air temperature is high, the consumer may overcool the room in advance, to thereby lower the room temperature. As a result, the room temperature can be prevented from abruptly increasing even when cooling is stopped during the peak time period. In this Way, by performing a so-called peak shifting, a demand adjustment that is less burdensome for the consumers can be achieved.

Here, the power trader sells power during the time period in which the wholesale power price is high and, at the same time, purchases additional power, which is required for the overheating or the overcooling, at a time when the wholesale power price is low. A difference between the amount of money obtained by selling power when the wholesale power price is high, and the amount of money paid to purchase the additional power for peak shifting is the source of profit of the power trader.

Such trading of the adjustment power amount through the so-called power transaction market can be performed by a power provider alone if the power provider has a retail license. When the power provider does not have a retail license, the power provider trades the adjustment power amount through a retailer.

Each of the consumers is in a different situation, and thus may not be able to participate in the power adjustment during the peak time period designated by the power trader. The effect obtained by performing the peak shifting through the overheating or the overcooling also greatly differs depending on a heat capacity of a building, a specification of the equipment, or the like of each of the consumers. Therefore, when trading in the power transaction market, the power trader who manages the group of consumers together needs to consider in advance the temporal fluctuation in the power amount adjustable by each of the consumers. Here, a group of consumers that is a target be grouped together by the power trader may be referred to as a resource.

In this Embodiment, a power transaction management system 1 is proposed in view of features that are characteristic of a case in which the group of consumers is grouped together to purchase and sell power in the market. The power transaction management system 1 of this Embodiment includes a power transaction management apparatus 20 configured to manage the power transaction, and a resource availability evaluation apparatus 21 configured to evaluate an availability of the resource, for example. The power transaction management system 1 of this Embodiment evaluates the temporal fluctuation in the adjusting ability of the resource in advance, and then establishes an adjustment amount transaction corresponding to the fluctuation in the wholesale power price.

The resource availability evaluation apparatus 21 forecasts an adjusting ability of a representative consumer among the consumers forming the resource on the basis of a physical feature of the equipment of the representative consumer or an operating condition of the representative consumer. The resource availability evaluation apparatus 21 forecasts the adjusting ability of the resource on the basis of the forecasted adjusting ability of the representative consumer. On the basis of the forecasted adjusting ability of each resource and a constraint condition relating to the operation of the resource, the resource availability evaluation apparatus 21 crafts an adjustment plan that satisfies a target adjustment value that is given for each predetermined time frame.

The power transaction management apparatus 20 calculates a forecasted value of a wholesale power transaction price of a predetermined period in the future from an agreement result of the past, which is received from a market operation management apparatus 50. The power transaction management apparatus 20 detects a pair of power products to be purchased and sold that satisfies a transaction criteria on the basis of a threshold value configured in advance, and then determines a pair of power products that can be traded with use of the resource availability evaluation apparatus 21. The power transaction management apparatus 20 determines whether a profitability obtained when the trading of the determined pair of power products is completed satisfies the criteria configured in advance. The power transaction management apparatus 20 generates order data for trading the pair of power products that satisfies the criteria of profitability, and then sends the order data to the market operation management apparatus 50. The power transaction management apparatus 20 can also modify the transaction plan on the basis of an agreement state received from the market operation management apparatus 50 and a predetermined time limit for changing the adjustment plan.

### Embodiment 1

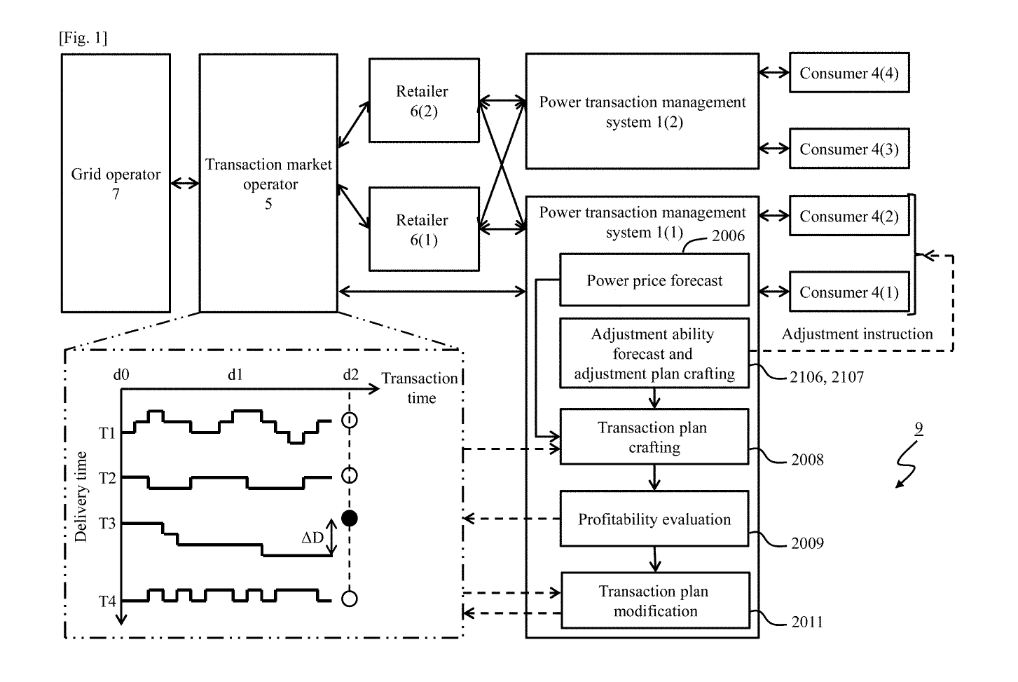

FIG. 1 is a conceptual diagram of the whole concept including the power transaction management system 1. An overview of the operation of computers managed by participants of the power transaction market is described with reference to FIG. 1. In FIG. 1, names of the participants are shown for better understanding, but the actual processing is executed by the computers managed by each of the participants.

Power generated by power plants such as a thermal power plant, a hydraulic power plant, a nuclear power plant, a wind power plant, or a photovoltaic power plant is supplied to each of the consumers through power transmission lines, a substation, and the like. Here, the power producer and a power transmission and distribution operator are referred to as a grid operator 7 without distinction.

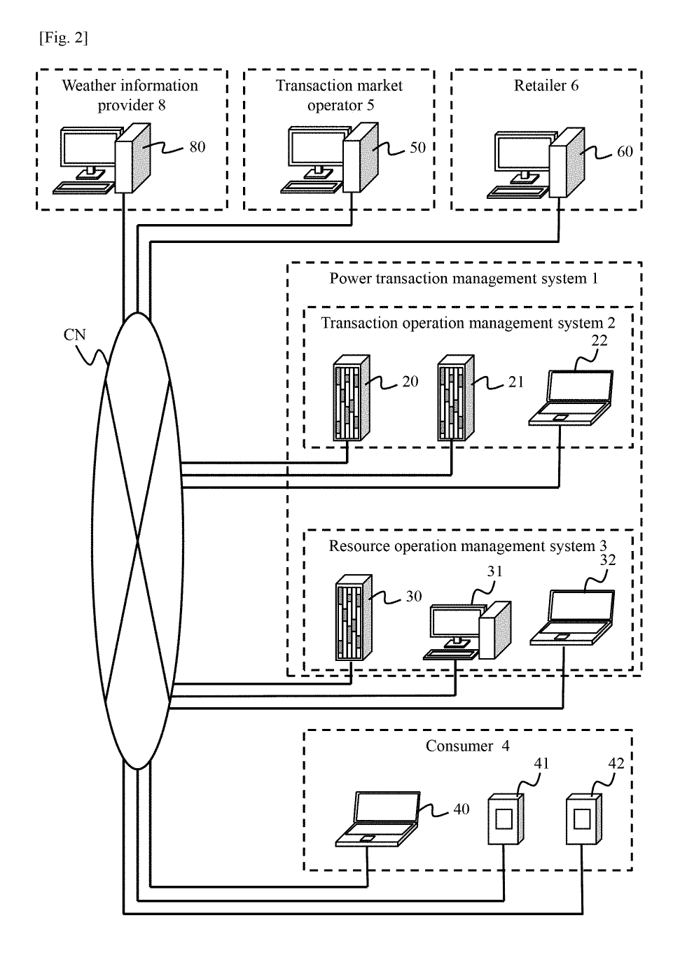

The computer managed by the grid operator 7 is coupled to a computer 50 (see FIG. 2) managed by a transaction market operator 5 who operates the power transaction market. In FIG. 1, only one grid operator 7 is illustrated, but a plurality of grid operators 7 may participate in the same power transaction market. A computer 60 (see FIG. 2) managed by one or more power retailers 6(1) and 6(2) is coupled to the computer 50 managed by the transaction market operator 5. There may be three or more power retailers 6. The power retailer 6 is hereinafter referred to as a retailer 6 when no distinction is made.

A predetermined computer 20 (see FIG. 2) among a group of computers managed by power traders 1(1) and 1(2) is coupled to at least one of the computer 60 of the retailer 6 and the computer 50 of the transaction market operator 5. The power traders 1 may trade power in the power transaction market through one or more retailers 6, or may directly trade power in the power transaction market without intermediation of the retailer 6.

In FIG. 1, two power traders 1(1) and 1(2) are illustrated, but it is sufficient when there is at least one power trader, and there may be three or more power traders. When distinction is not made, the power traders 1(1) and 1(2) are referred to as a power trader 1. A computer program formed of one or more computers managed by the power trader 1 corresponds to the power transaction management system. Therefore, the computer program may be referred to as the power transaction management system.

Other predetermined computers 30 and 31 (see FIG. 2) among the group of computers managed by the power trader 1 are coupled to computers 41 and 42 (see FIG. 2) managed by consumers 4(1) and 4(2). When distinction is not made, the consumers 4(1) and 4(2) are referred to as a consumer 4.

The power transaction management system 1 communicates to/from the computer 50 of the transaction market operator through the computer of the retailer 6 or directly, to thereby purchase and sell the power product. Further, the power transaction management system 1 collects information between the computers 41 and 42 managed by the consumer 4, and gives an instruction to adjust power for the purchasing and selling of the power product.

Details are described later, but the power transaction management system 1 includes a function 2006 of forecasting the power price (hereinafter referred to as the wholesale power price) in the power transaction market, and a function 2107 of crafting a plan regarding power to be reduced and adjusted by each of the consumers 4. Further, the power transaction management system 1 includes a function 2008 of crafting the transaction plan for trading the power product in the power transaction market on the basis of the forecasted power price and the adjustment plan. Further, the power transaction management system 1 includes a function 2009 of evaluating a profit of the transaction plan, and a function 2011 of modifying the transaction plan when required.

In the power transaction market, the power price for each time block fluctuates momentarily. A graph shown below the transaction market operator 5 is for showing the fluctuation in the power price, which is the price of the power product. The vertical axis divides the time of a day into time blocks in predetermined units (for example, units of 30 minutes, units of 60 minutes, or the like). The time blocks are adjacent to each other and there are no gaps therebetween. For example, when the units of 30 minutes are applied, the time of the day is divided into 48 time blocks such as from 00:00 to 00:30, from 00:30 to 01:00, from 01:00 to 01:30, from 01:30 to 02:00, . . . , from 23:00 to 23:30, and from 23:30 to 00:00. In FIG. 1, those time blocks in the predetermined units are indicated as T1, T2, T3, and T4.

The horizontal axis of the graph for showing the fluctuations in the power price indicates dates of the transaction. A plurality of dates, for example, 3 days are indicated. In FIG. 1, dates of 3 days, that is, 2 days before (d0=(d2−2 days)), 1 day before (d1=(d2−1 day)), and today (d2) are indicated.

When focused on a certain day, the power prices in the time blocks are different from each other. For example, the power demand is high in the time block in which a cooling and heating equipment is activated, the time block in which meals are prepared, and the like, and thus the power prices in those time blocks tend to increase. On the other hand, the power demand is low in the time block in the middle of the night and the like in which the activity level decreases, and thus the power prices in those time blocks tend to decrease. Further, for example, in the summer season and the winter season, the power demand is high, and thus the power prices tend to increase. On the other hand, for example, in spring and autumn, the power demand is low, and thus the power prices tend to decrease. The power demand also rises and falls depending on the types of the consumers that the power transaction management system groups together. The types of the consumers include, for example, a standard home, a commercial facility, a hospital, and a factory.

The function 2006 of forecasting the power price of the power transaction management system 1 can forecast the power prices of the next few days. The circles shown on the right edge of the graph indicates the power prices forecasted two days before (d0). The white circles indicate that a difference between the forecasted power price and the actual power price falls within a predetermined acceptable range. The black circle indicates that a difference between the forecasted power price and the actual power price does not fall within the predetermined acceptable range.

As shown by the black circle in FIG. 1, a case in which the forecasted power price of a certain time block T3 is lower than the actual power price by ΔD is conceived. When power is planned to be sold at the forecasted power price, the actual price is lower than the planned price by ΔD, and thus there is a fear of negative earnings. In that case, the function 2011 of modifying the transaction plan of the power transaction management system 1 modifies the power transaction plan.

In this way, the power transaction management system 1 of this Embodiment achieves appropriate power transaction on two different time axes, that is, optimization on a power delivery time axis, and optimization on a transaction time axis. The optimization on the power delivery time axis means, for example, to purchase power of the time block in which the power price is low from the market, to thereby reduce the power consumption by the group of consumers during the time block in which the power price is high, and to sell the amount of power that is reduced as the adjustment power in the market. The profit is increased as the purchase price becomes higher than the selling price. The profit becomes the profit of the power trader. A part of the profit may be passed on to the consumer 4. In order to fulfill the transaction plan, the power transaction management system 1 instructs the consumer 4 under management to reduce and adjust the power consumption amount. The computer 41 (see FIG. 2) of the consumer 4, which received the instruction, reduces the power consumption amount by switching off the load equipment, turning up and down the set temperature thereof, and the like. The amount of power that is reduced (adjustment power) is sold to another power transaction management system or the retailer 6 that have reserved a purchase of power in that time block.

FIG. 2 illustrates the whole system including the power transaction management system 1. The power transaction management system 1 (power trader), the consumer 4, the transaction market operator 5, the retailer 6, a weather information provider 8, the grid operator 7 (only shown in FIG. 1), for example, are coupled to a communication network CN. Hereinafter, a computer owned by a business operator and the business operator are hereinafter described without distinction.

The power transaction management system 1 is a system configured to trade the adjustment power, which the power trader procured from the resource (group of consumers) on the basis of a contract, in the power transaction market. The trading is performed directly or through the retailer.

The power trader may include a transaction operation manager and a resource operation manager, for example. The transaction operation manager is a business operator who procures the adjustment power from the consumer 4 on the basis of a contract, and devises and executes the transaction plan in the power transaction market directly or through the retailer 6. The resource operation manager is a business operator who refers to the adjustment plan devised by the transaction operation manager, to actually execute the operation of the resource. The power trader does not always need to be divided into the transaction operation manager and the resource operation manager, and the same business operator may manage both the operation of the transaction and the operation of the resource.

A transaction operation management system 2 is a computer system managed by the transaction operation manager, and includes the power transaction management apparatus 20, the resource availability evaluation apparatus 21, and the information input-output terminal 22, for example. The power transaction management apparatus 20 is a computer configured to exchange information, which is necessary for the power transaction, in the power transaction market. The resource availability evaluation apparatus 21 is a computer configured to evaluate the amount of power that the group of consumers serving as the resource can adjust in a predetermined time block. The information input-output terminal 22 is a computer configured to input instructions and information to each of the management apparatuses 20 and 21, and display processing results or the like of each of the management apparatus 20 and 21.

A resource operation management system 3 is a computer system configured to manage the operation of each of the consumers 4 serving as the resource, and includes a resource operation management apparatus 30, a resource information management apparatus 31, and an information input-output terminal 32, for example. The resource operation management apparatus 30 is a computer configured to give instructions on power adjustment to each of the consumers 4 serving as the resource in accordance with the adjustment plan. When resource operation is executed, the resource operation management apparatus 30 sends a control signal to the control apparatus 41 of the consumer 4, to thereby control the equipment of the consumer 4. The resource information management apparatus 31 is a computer configured to obtain information on each of the consumers 4. The information input-output terminal 32 is a computer for inputting and outputting information from and to each of the management apparatuses 30 and 31.

The configuration of the power transaction management system 1 is not limited to the example shown in FIG. 2. The power transaction management system 1 may be formed of one physical computer, and may implement functions that are equivalent to those of the management apparatuses 20, 21, 22, 30, 31, and 32 described above in the physical computer. Alternatively, the power transaction management system 1 may have a configuration in which the management apparatuses 20 and 21 are combined into a single computer, and the management apparatuses 30 and 31 are combined into another single computer.

The consumer 4 is an individual or a corporation having the load equipment (not shown). The load equipment may include various types of apparatuses that consume electric energy such as illuminating apparatuses, air-conditioning apparatuses, refrigerators, freezers, and hot-water storing apparatuses, for example.

The consumer 4 include, for example, an information input-output terminal 40, a control apparatus 41, and a measuring apparatus 42. The consumer 4 sends information on an equipment that the consumer 4 owns, information on operation of the equipment that the consumer 4 owns, information on a building, and the like to the power transaction management system 1 through the information input-output terminal 40. The control apparatus 41 controls the operation of the equipment that the consumer 4 owns in response to the control signal received from the power transaction management system 1. The measuring apparatus 42 obtains information indicating an environment of the consumer such as the room temperature, the outside air temperature, the amount of insolation, the operation state of the equipment, for example, and sends the information to the power transaction management system 1. The information described above is only an example, and there is no need for the measuring apparatus 42 to always obtain all the information described above. It is sufficient that the measuring apparatus 42 can obtain information necessary for an appropriate power adjustment.

Through a distribution network operated by the grid operator 7, the retailer 6 supplies the consumer 4 with the power procured from the power transaction market. The retailer may also purchase back apart of the power that is planned to be supplied to the consumer 4 from the consumer 4 through the power trader. The retailer 6 includes a transaction information management apparatus 60 for communicating information on transaction with the power transaction management system 1 or the power transaction market.

The transaction market operator 5 is a business operator who operates the power transaction market, and includes the market operation management apparatus 50. The market operation management apparatus 50 exchanges information on the power transaction among the apparatus 60 of the retailer 6, the power transaction management system 1, and the apparatus of the grid operator 7.

The weather information provider 8 owns a weather information distributing apparatus 80. The weather information distributing apparatus 80 is configured to distribute weather forecast information or weather information of the past to the power transaction management system 1 and the like.

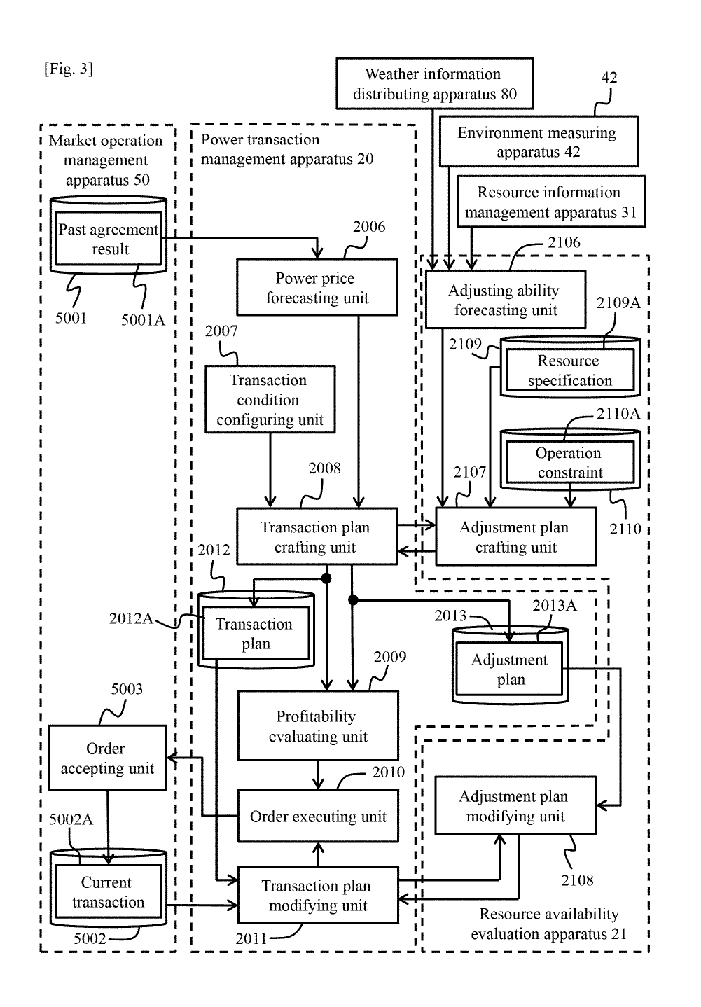

With reference to FIG. 3, a relationship between a flow of processing and functions of the power transaction management system 1 is described. As described above, the power transaction management system 1 includes the transaction operation management system 2 configured to craft and execute the plan of the power transaction corresponding to the state of the group of consumers serving as the resource, and the resource operation management system 3 configured to instruct the group of consumers to adjust power at a predetermined timing. The transaction operation management system 2 is configured to dynamically create the transaction plan in consideration of individual situations of the group of consumers, and mainly includes the power transaction management apparatus 20 and the resource availability evaluation apparatus 21.

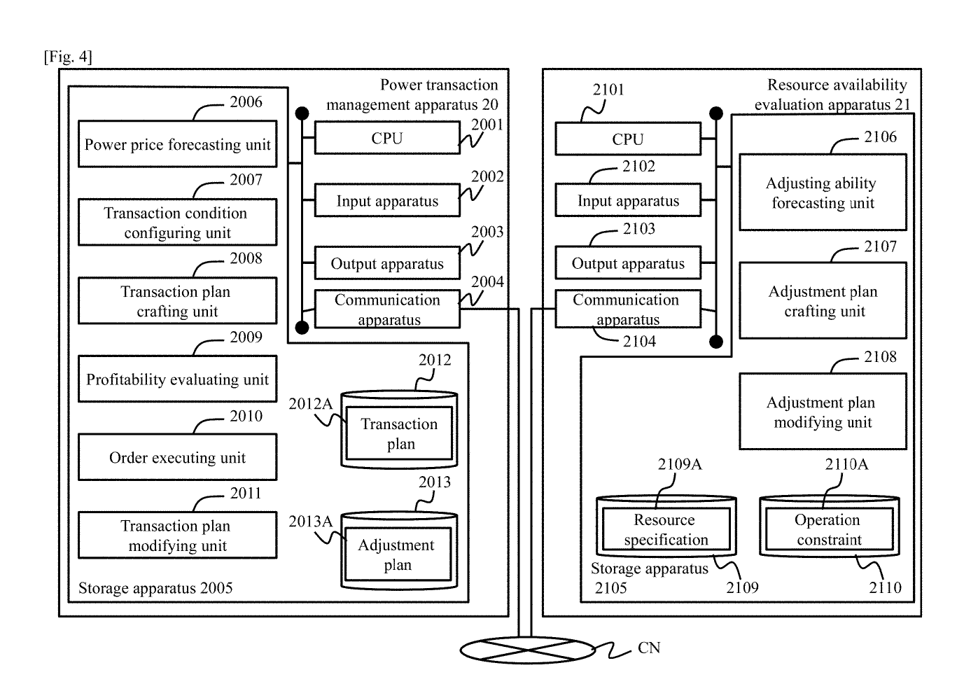

The power transaction management apparatus 20 includes a power price forecasting unit 2006, a transaction condition configuring unit 2007, a transaction plan crafting unit 2008, a profitability evaluating unit 2009, an order executing unit 2010, a transaction plan modifying unit 2011, and a transaction plan information storing unit 2012, for example. Details are described later with reference to FIG. 4.

An outline is described here. The power transaction management apparatus 20 generates transaction plan information 2012A on the basis of past agreement result information 5001A indicating agreement results of the past, and adjustment plan information 2013A. The market operation management apparatus 50 stores and manages the past agreement result information 5001A in a past agreement result information storing unit 5001, and then sends the past agreement result information 5001A to the power transaction management apparatus 20 in response to a request from the power transaction management apparatus 20.

The resource availability evaluation apparatus 21 crafts the adjustment plan information 2013A, to thereby send the adjustment plan information 2013A to the power transaction management apparatus 20. The power transaction management apparatus 20 receives the adjustment plan information 2013A and stores received the adjustment plan information 2013A in an adjustment plan information storing unit 2013. The storing unit 2013 configured to store the adjustment plan information 2013A may be arranged in the resource availability evaluation apparatus 21. In FIG. 3, the past agreement result information 5001A is illustrated as the past agreement result 5001A, the adjustment plan information 2013A is illustrated as the adjustment plan information 2013A, and the transaction plan information 2012A is illustrated as the transaction plan 2012A.

The power transaction management apparatus 20 generates the transaction plan information 2012A with use of the adjustment plan information 2013A, and stores the transaction plan information 2012A in the transaction plan information storing unit 2012. The power transaction management apparatus 20 generates the order data for accomplishing the transaction plan information 2012A, and sends the generated order data to the market operation management apparatus 50. The market operation management apparatus 50 receives the order data from the power transaction management apparatus 20, and accepts the order data received from the power transaction management apparatus 20 at an order accepting unit 5003. The market operation management apparatus 50 stores and manages the accepted order data in a current transaction storing unit 5002 as a part of current transaction information 5002A.

As described above, a plurality of retailers 6 and power traders are participating in the power transaction market, and the power demand also fluctuates due to abrupt change in the weather, unexpected events or the like. Thus, the power price in the power transaction market changes from day to day. Therefore, the power product may not always be purchased and sold at a power price planned by the power transaction management system 1. When the actual power price is lower than the planned power price by an amount equal to or larger than a predetermined price difference on the agreement scheduled date, there is a fear of negative earnings, and thus the power transaction management system 1 cannot allow the adjustment power to be sold to the power transaction market. Even when the actual power price is higher than the planned power price by an amount equal to or larger than the predetermined price difference on the agreement scheduled date, there is a fear of negative earnings, and thus the power transaction management system 1 cannot allow the power, which is used in an advance preparation for adjusting the power consumption, to be purchased from the power transaction market.

As described above, in the market in which the power price fluctuates, there may be cases in which the transaction of the order data that is originally generated on the basis of the transaction plan information 2012A is not established. Thus, the power transaction management apparatus 20 modifies the transaction plan information 2012A on the basis of the current transaction information 5002A received from the market operation management apparatus 50, and the transaction plan information 2012A that is originally generated. Then, the power transaction management apparatus 20 newly generates order data for changing the content of the transaction, and sends the new order data to the market operation management apparatus 50. The new order data is stored in the current transaction storing unit 5002 as a part of the current transaction information 5002A.

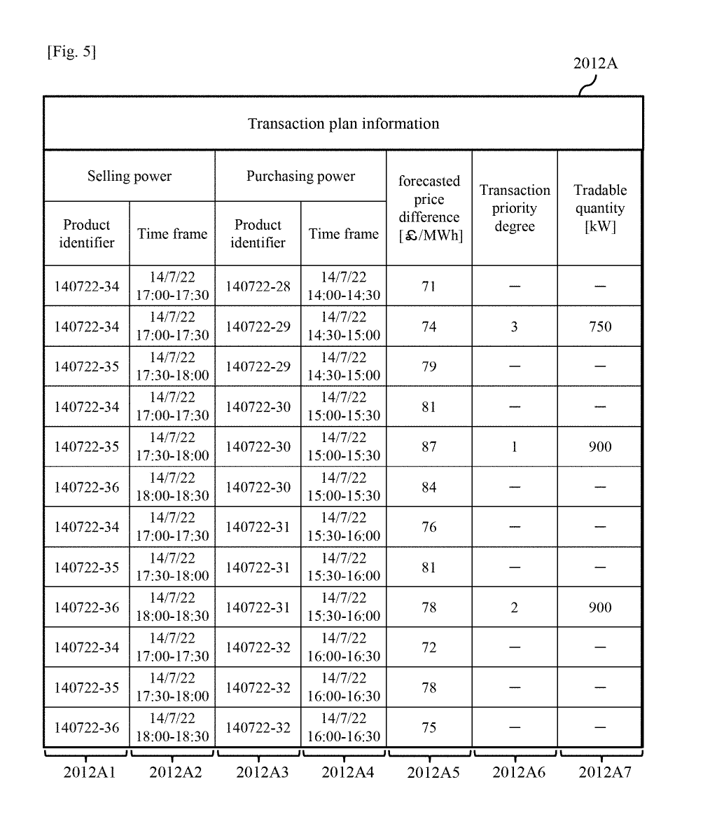

A configuration example of the transaction plan information 2012A held by the power transaction management apparatus 20 is described with reference to FIG. 5. A brief overview is described here. The transaction plan information 2012A may include a product identifier for distinguishing between a selling order and a purchasing order, a price difference between the selling order and the purchasing order, and the amount of transaction to be ordered, for example. The adjustment plan information 2013A held by the power transaction management apparatus 20 may include an adjustment target value for a predetermined time frame of each of the resources, for example.

An overview of the resource availability evaluation apparatus 21 is described. The resource availability evaluation apparatus 21 forecasts the adjusting ability of the resource on the basis of information received from the weather information distributing apparatus 80, information received from the measuring apparatus 42, and information received from the resource information management apparatus 31. The resource availability evaluation apparatus 21 crafts the adjustment plan information 2013A on the basis of the result of forecast by the adjusting ability of the resource, resource specification information 2019A, and operation constraint information 2110A. The resource availability evaluation apparatus 21 sends the generated adjustment plan information 2013A to the power transaction management apparatus 20. A case in which the power transaction management apparatus 20 stores the adjustment plan information 2013A in storing unit 2013 is described with reference to FIG. 3. However, this invention is not limited thereto, and the resource availability evaluation apparatus 21 may store the adjustment plan information 2013A in the storing unit 2013.

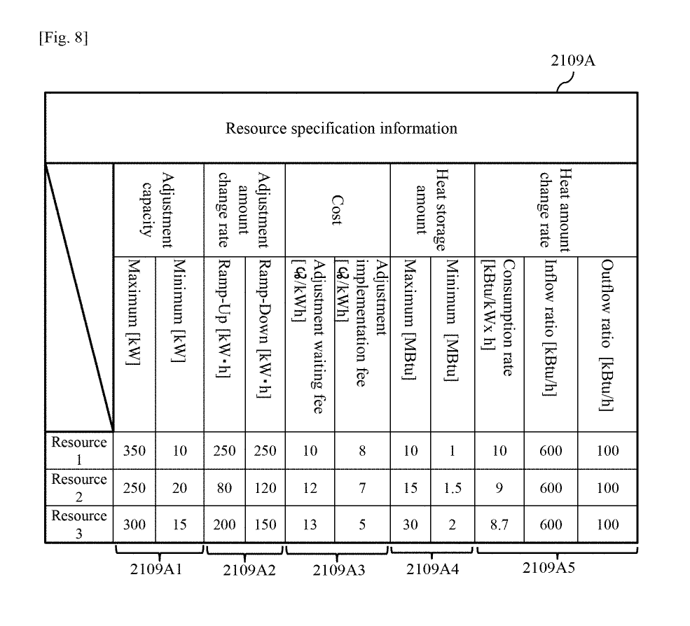

A configuration example of the resource specification information 2019A held by the resource availability evaluation apparatus 21 is illustrated in FIG. 8. When a brief description is made here, the resource specification information 2019A may include, for each of the resources (consumers 4), a maximum value and a minimum value of an adjustment capacity, a temporal change rate of the adjustment power amount, the cost required for the adjustment, the heat storage amount, and a change rate of the heat amount, for example.

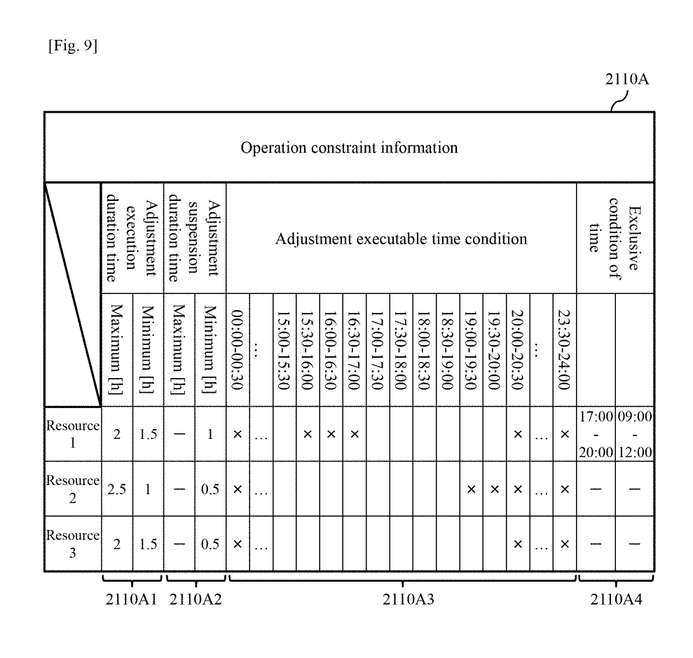

A configuration example of the operation constraint information 2110A held by the resource availability evaluation apparatus 21 is described with reference to FIG. 9. In short, the operation constraint information 2110A may include, for each of the resources, a maximum value and a minimum value of a duration time of the execution of the adjustment, a maximum value and a minimum value of a duration time of the suspension of the adjustment, specified conditions for a time frame in which the adjustment can be executed, and exclusive conditions for the time frame, for example. The exclusive conditions for the time frame include a condition under which only one of an adjustment of the power consumption in the morning and an adjustment of the power consumption in the evening can be executed, for example.

With reference to FIG. 4, an example of a function configuration of the power transaction management apparatus 20 and the resource availability evaluation apparatus 21 is described.

The power transaction management apparatus 20 is configured as an information processing apparatus such as a personal computer, a server computer, or a handheld computer, for example. The power transaction management apparatus 20 is not necessarily configured as one apparatus, and may be configured through a plurality of apparatuses in cooperation. The power transaction management apparatus 20 may include a CPU (Central Processing Unit) 2001, an input apparatus 2002, an output apparatus 2003, a communication apparatus 2004, and a storage apparatus 2005, for example.

The CPU 2001 serving as a “processing unit” reads and executes a predetermined computer program stored in a storing unit 2005, to thereby integrally control the operation of the power transaction management apparatus 20.

The input apparatus 2002 is an apparatus with which an operator inputs information into the power transaction management apparatus 20. The information to be input includes days and instructions. For example, a keyboard, a mouse, a touch panel, a speech recognition apparatus, a motion recognition apparatus, and the like are used to form the input apparatus 2002. The output apparatus 2003 is an apparatus configured to output information from the power transaction management apparatus 20 to the outside. For example, a display, a printer, a speech synthesis apparatus, and the like are used to form the output apparatus 2003. The communication apparatus 2004 is an apparatus configured to communicate through the communication network CN. The communication unit 2004 includes an NIC (Network Interface Card) for coupling the communication unit 2004 to a wireless LAN (Local Area Network) or a wired LAN, for example.

The storage apparatus 2005 is an apparatus configured to store data into a storage medium such as a RAM (Random Access Memory), a ROM (Read Only Memory), a hard disk, and a flash memory. In FIG. 4, the storage apparatus 2005 is illustrated as one apparatus, but the storage apparatus 2005 may be formed of a plurality of storage apparatuses, for example, may be formed of a main storage apparatus and an auxiliary storage apparatus.

The storage apparatus 2005 serving as a “memory unit” has a group of computer programs 2006 to 2011, and a group of databases 2012 and 2013 stored therein. The group of computer programs is described first, and then the group of databases is described.

The storage apparatus 2005 has predetermined computer programs for realizing functions such as the power price forecasting unit 2006, the transaction condition configuring unit 2007, the transaction plan crafting unit 2008, the profitability evaluating unit 2009, the order executing unit 2010, the transaction plan modifying unit 2011, and the like, for example. The storage apparatus 2005 also has an operating system, a device driver, and the like stored therein, but illustration thereof is omitted.

The power price forecasting unit 2006 is a program for executing “power price forecasting processing”. Specifically, the power price forecasting unit 2006 is a program for forecasting a power price for each of the power products over a predetermined future period on the basis of the agreement result information 5001A of the past obtained from the market operation management apparatus 50.

The transaction condition configuring unit 2007 is a program for configuring conditions necessary for trading power in the power transaction market. Values to be configured as the transaction conditions are a threshold value of the power price difference and a threshold value of a difference in delivery time, for example.

The power transaction management system 1 is configured to reduce the power consumption of the resource during the time block in which the power demand is high, and sell the amount of power that is reduced by the resource to the power transaction market as the power product. Further, the power transaction management system 1 is configured to purchase power to be used for a preprocessing of the power consumption adjustment from the power transaction market. The preprocessing is a processing of lowering or raising the room temperature by a great amount before the adjustment of the power consumption, for example.

In this way, the power transaction management system 1 sells the power product procured from the resources to the power transaction market, and purchases the power product to be additionally supplied to the resource from the power transaction market. When the power price of the power product of the selling order is not higher than the power price of the power product of the purchasing order corresponding to the selling order, the transaction results in a negative earning. Thus, the power transaction management system 1 requests a threshold value of the power price difference to be configured as one of the transaction conditions.

Further, when the time difference between the time at which the resource performs the preprocessing for the power consumption adjustment, and the time block in which the resource adjusts the power consumption is too small, the resource may not be able to respond. For example, some types of equipment do not immediately change to a predetermined operation state after the operation is started, and take time to change to the operation state. In the same manner, equipment taking time to change from the operation state to a suspended state after the operation is stopped. Therefore, in order to attain the effect of a pre-adjustment, the power transaction management system I requests a threshold value of a time difference between a delivery time of the power product of the selling order and a delivery time of the power product of the purchasing order to be configured as another one of the transaction conditions.

The transaction plan crafting unit 2008 is a program for crafting the transaction plan for purchasing and selling a selected power product in the power transaction market on the basis of the transaction conditions configured by the operator, and a future power price that is forecasted. The transaction plan is crafted as the transaction plan information 2012A, and is stored in a transaction plan information storing unit 2012. The transaction plan information 2012A may be hereinafter abbreviated to “transaction plan 2012A”.

The transaction plan crafting unit 2008 executes “power product extracting processing” and “transaction plan crafting processing”. Specifically, in response to a forecasted value of the power price for each of the power products that the power price forecasting unit 2006 forecasted, the transaction plan crafting unit 2008 detects all pairs of the power products that meet both the threshold value of the price difference and the threshold value of the time difference configured by the transaction condition configuring unit 2007. Then, out of the detected pairs of power products, the transaction plan crafting unit 2008 determines the pairs of power products to be traded on the basis of priority degrees configured in advance, for example, an order of price differences in descending order. Then, the transaction plan crafting unit 2008 calculates the adjustment power amount of the time frame in which the selling order is performed through use of the resource availability evaluation apparatus 21, to thereby determine the quantity of the determined pairs of power transaction products that can be traded. Specifically, the transaction plan crafting unit 2008 determines the adjustment power amount, which is the content of the power product to be sold, on the basis of the result of evaluation by the resource availability evaluation apparatus 21. The adjustment power amount means power that is obtained through the reduction and adjustment of the power consumption performed by the resources, and is also referred to as an adjustment amount or a transaction amount.

The profitability evaluating unit 2009 is a program for executing “profit forecasting processing” and “profitability determining processing”. The profitability evaluating unit 2009 calculates a forecasted profit on the basis of the transaction plan crafted by the transaction plan crafting unit 2008, and determines whether the forecasted profit satisfies a profit condition that is configured in advance.

The order executing unit 2010 is a program for executing “ordering processing”. The order executing unit 2010 generates order data on the basis of the transaction plan that satisfies the profit condition, and sends the order data to the market operation management apparatus 50. Further, the order executing unit 2010 sends the adjustment plan corresponding to the transaction plan to the resource operation management apparatus 30. The resource operation management apparatus 30 executes “adjustment plan sending processing”, to thereby send the adjustment plan to the resource. Here, the control apparatus 41 of each of the consumers 4 only receives the adjustment plan relating to the control apparatus 41 itself.

The transaction plan modifying unit 2011 is a program for executing “transaction plan modifying processing”. The transaction plan modifying unit 2011 modifies the transaction plan 2012A on the basis of the current agreement state information 5002A obtained from the market operation management apparatus 50.

The group of databases stored in the storage apparatus 2005 is described. In the storage apparatus 2005, databases such as the transaction plan information storing unit 2012, the adjustment plan information storing unit 2013, and the like are stored.

The transaction plan information storing unit 2012 holds the transaction plan information 2012A. The adjustment plan information storing unit 2013 holds the adjustment plan information 2013A. The transaction plan information 2012A is information on the transaction plan crafted by the transaction plan crafting unit 2008. Details are described later. The adjustment plan information 2013A is information on the adjustment plan crafted by the resource availability evaluation apparatus 21. Details are described later.

The resource availability evaluation apparatus 21 is an information processing apparatus such as a personal computer, a server computer, or a handheld computer, for example. The resource availability evaluation apparatus 21 is not necessarily configured as one apparatus, and may be configured through a plurality of apparatuses in cooperation. For example, the resource availability evaluation apparatus 21 and the power transaction management apparatus 20 may be integrated.

The resource availability evaluation apparatus 21 may include a CPU 2101, an input apparatus 2102, an output apparatus 2103, a communication apparatus 2104, and a storage apparatus 2105, for example.

The CPU 2101 may form a “processing unit” together with the CPU 2001 of the power transaction management apparatus 20. The CPU 2101 integrally controls the operation of the resource availability evaluation apparatus 21.

The input apparatus 2102 corresponds to the input apparatus 2002 of the power transaction management apparatus 20. The output apparatus 2103 corresponds to the output apparatus 2003 of the power transaction management apparatus 20. The communication apparatus 2104 corresponds to the communication apparatus 2004 of the power transaction management apparatus 20. Therefore, description of those apparatuses 2102 to 2104 is omitted.

The storage apparatus 2105 may form a “memory unit” together with the storage apparatus 2005 of the power transaction management apparatus 20. The storage apparatus 2105 has various types of computer programs such as an adjusting ability forecasting unit 2106, an adjustment plan crafting unit 2107, and an adjustment plan modifying unit 2108 stored therein.

The adjusting ability forecasting unit 2106 is a program for forecasting the adjusting ability of the resource on the basis of information on the building or the equipment of the resource, information on the environment of the resource of the past (such as the room temperature), and information on the forecasted outside air temperature of the location of the resource. The information on the building or the equipment of the resources is obtained from the resource information management apparatus 31. A record of the room temperature of the resource of the past (room temperature history) is obtained from the measuring apparatus 42. The information on the forecasted outside air temperature of the location of the resource is obtained from the weather information distributing apparatus 80. The adjusting ability may be forecasted for each of the consumers 4 configuring the resource, or a consumer representing the resource may be selected, to thereby forecast the adjusting ability of the representative consumer. In the latter case, on the basis of the adjusting ability of the representative consumer, the adjusting ability of the whole resource can be calculated. In this Embodiment, as described below, the adjusting ability of the representative consumer is forecasted in order to reduce the load of arithmetic processing.

The adjusting ability of the resource is, for example, information indicated by a physical quantity such as the adjustment power amount of the resource or the heat amount in the resource. The heat amount in the resource is a heat amount that fluctuates because of the adjustment of the power consumption by the resource.

The adjustment plan crafting unit 2107 is a program for executing “adjustment plan crafting processing”. On the basis of the resource specification information 2019A, the operation constraint information 2110A, and the result of forecast by the adjusting ability forecasting unit 2106, the adjustment plan crafting unit 2107 crafts the adjustment plan information 2013A for implementing the transaction plan crafted by the transaction plan crafting unit 2008. Specifically, the adjustment plan crafting unit 2107 determines the adjustment power amount for each of the resources such that the target adjustment value for each time frame given by the transaction plan crafting unit 2008 is satisfied. The adjustment plan information 2013A is stored in the adjustment plan information storing unit 2013. The adjustment plan information storing unit 2013 may be arranged in the power transaction management apparatus 20, or may be arranged in the resource availability evaluation apparatus 21. Alternatively, the adjustment plan information storing unit 2013 or the like may be arranged in a separate storage apparatus that is different from either of the power transaction management apparatus 20 and the resource availability evaluation apparatus 21. Any configuration may be used as long as the power transaction management apparatus 20 and the resource availability evaluation apparatus 21 can have access to and use information as necessary, and the configuration is not limited to the configuration example illustrated in the drawings.

The adjustment plan modifying unit 2108 is a program for executing “adjustment plan modifying processing”. The adjustment plan modifying unit 2108 modifies the adjustment plan held in the adjustment plan information storing unit 2013 on the basis of the information obtained from the transaction plan modifying unit 2011.

The storage apparatus 2105 also has databases such as the resource specification information storing unit 2109, the operation constraint information storing unit 2110, and the like stored therein. The resource specification information storing unit 2109 holds resource specification information 2109A. The operation constraint information storing unit 2110 holds the operation constraint information 2110A. The source specification information 2109A is information on a specification of the resource related to the adjustment of the power consumption. Details are described later. The operation constraint information 2110A is information on constraints on the operation of the resource. Details are described later.

FIG. 5 is a configuration example of the transaction plan information 2012A. The transaction plan information 2012A is information generated by the transaction plan crafting unit 2008, and has stored therein candidates for the pair of power products satisfying a predetermined condition. The transaction plan information 2012A is used when the order executing unit 2010 generates the order data. The transaction plan information 2012A is also used when the transaction plan modifying unit 2011 modifies the transaction plan.

The transaction plan information 2012A includes, for example, a selling power product identifier field 2012A1, a delivery time frame field 2012A2, a purchasing power product identifier field 2012A3, a delivery time frame field 2012A4, a forecasted price difference field 2012A5, a transaction priority degree field 2012A6, and a tradable quantity field 2012A7.

The selling power product identifier field 2012A1 stores identifiers for identifying the candidates for the power product to be sold. The delivery time frame field 2012A2 stores information indicating time blocks in which the power product candidates that are the targets of sale are sold. The purchasing power product identifier field 2012A3 stores identifiers for identifying the candidates for the power product to be purchased. The delivery time frame field 2012A4 stores information indicating purchasing time blocks of the power product candidates that the targets of purchase.

The forecasted price difference field 2012A5 stores differences each between a forecasted power price of the power product candidate that is the target of sale and a forecasted power price of the power product candidate that is the target of purchase. The transaction priority degree field 2012A6 stores priority degrees used to determine whether to order. The transaction priority degrees can be used as flag information indicating whether to order.

The transaction plan crafting unit 2008 first generates information on the field 2012A1 to the field 2012A5. Then, the transaction plan crafting unit 2008 generates information on the transaction priority degree field 2012A6 on the basis of the information on the field 2012A1 to the field 2012A5.

The priority degrees of the pairs of power products to be traded are stored in the transaction priority degree field 2012A6 as long as the time frames do not overlap. In the example of FIG. 5, the time frames in which the power products are sold, and the time frames in which the power products are purchased of the pairs of power products having “1”, “2”, and “3” respectively stored in the transaction priority degree field 2012A6 do not overlap each other. This is because it is generally not possible to simultaneously execute the delivery of different power products. Among the pairs of power products that are registered in the transaction plan information 2012A, the pairs of power products each having a value configured in the transaction priority degree field 2012A6 are selected as actual targets of transaction.

Finally, the transaction plan crafting unit 2008 stores a tradable quantity (power) of the selected pairs of power products in the tradable quantity field 2012A7. The transaction plan crafting unit 2008 requests the resource availability evaluation apparatus 21 to calculate the tradable quantity. The resource availability evaluation apparatus 21 calculates the quantity tradable by the resource on the basis of the transaction priority degree, and gives the calculated quantity to the transaction plan crafting unit 2008.

In the example of FIG. 5, the pair of power products of the selling power product identifier “140722-35” and the purchasing power product identifier “140722-30” shown in a fifth row has the highest forecasted price difference, and is thus configured to have the transaction priority degree of “1”. The tradable quantity of the pair of power products configured to have the transaction priority degree “1” is “900 kW”, which is the result of calculation by the resource availability evaluation apparatus 21.

In this Embodiment, the tradable quantity of the power products that are the targets of sale, and the tradable quantity of the power products that are the targets of purchase are described to be equal, but this invention is not limited thereto. For example, when the profit condition is satisfied, the tradable quantity of the power products that are the targets of sale, and the tradable quantity of the power products that are the targets of purchase may be different.

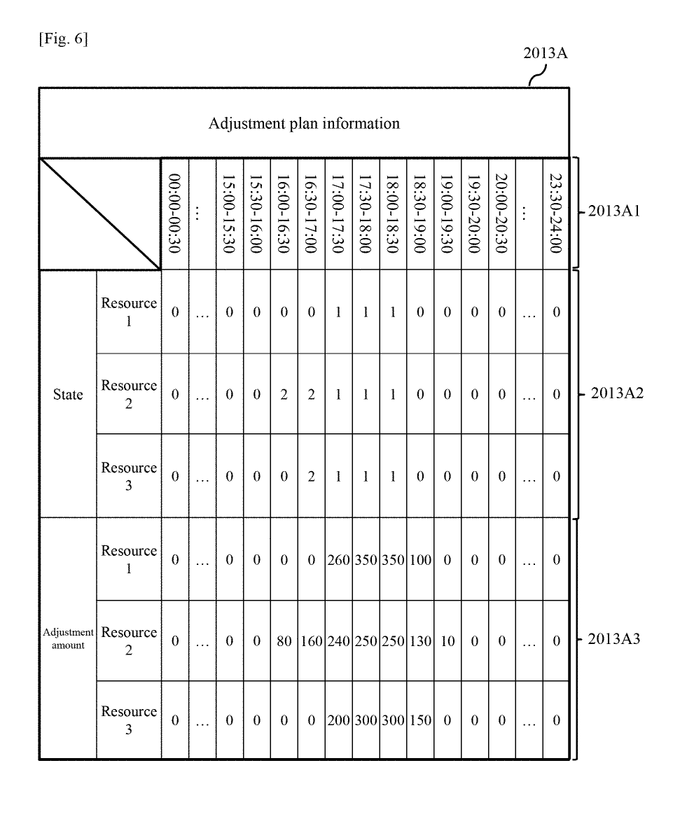

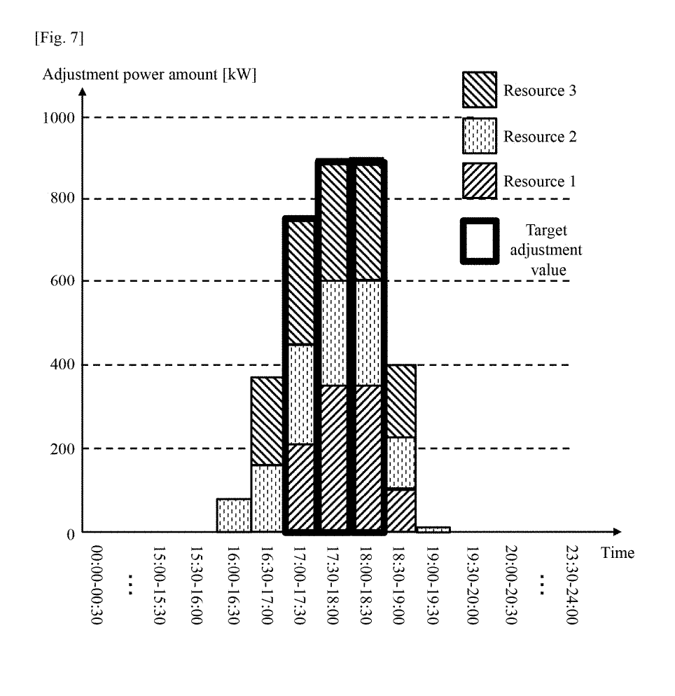

With use of FIG. 6 and FIG. 7, a configuration example and a displaying example of the adjustment plan information 2013A are described. The adjustment plan information 2013A is generated by the adjustment plan crafting unit 2107 of the resource availability evaluation apparatus 21.

The adjustment plan information 2013A is configured by associating, for each time frame field 2013A1 in which the adjustment is performed, a state value field 2013A2 relating the adjustment of the power consumption by each of the resources (each of the consumers 4) with an adjustment amount field 2013A3 indicating the adjustment amount allocated to each of the resources, for example.

The time frame field 2013A1 stores the starting time and the ending time of the power consumption adjustment and the length between the starting time and the ending time, which are given by the transaction plan crafting unit 2008. The state value field 2013A2 stores the state value relating to the adjustment for each of the resources in each time frame, which is the result of calculation by the adjustment plan crafting unit 2107. The adjustment amount field 2013A3 stores, as the target adjustment value, the value of the adjustment power amount allocated to each time frame of each of the resources, which is the result of calculation by the adjustment plan crafting unit 2107.

For example, in the example of FIG. 5, a “resource 1” has state values configured to “1” in three (plurality of) time frames, that is, time frames “from 17:00 to 17:30”, “from 17:30 to 18:00”, and “from 18:00 to 18:30”. The state value “1” indicates that the power consumption is adjusted in that time frame. The target adjustment power amount allocated to those three time frames are calculated as “260”, “350”, and “350”, respectively, as shown in the adjustment amount field 2013A3.

In a time frame “from 18:30 to 19:00”, which is a time frame after the end of the adjustment of the power consumption, and in time frames thereafter, a state value “0” is configured, which means that no adjustment is made. However, although the state value “0” is configured in the time frame “from 18:30 to 19:00”, which is the time frame immediately after the end of the adjustment, an adjustment power amount “100” is allocated thereto. This allocation of the adjustment power after the end of the adjustment indicates a recovery stage after the end of the adjustment. For example, some types of load equipment such as a central cooling and heating equipment requires time to change from the suspended state to the operation state, and to change from the operation state to the suspended state.

Attention is focused on a “resource 2” of FIG. 6. In the “resource 2”, two successive (plurality of) time frames, that is, time frames “from 16:00 to 16:30” and “from 16:30 to 17:00” each have a state value “2” configured therein.

The state value “2” indicates that the adjustment is started before the time frame in which the adjustment of the power consumption is originally executed. As described above, the adjustment power amount of some types of load equipment such as the central cooling and heating equipment have slow change rate, and hence the adjustment needs to be started early or else the target adjustment power amount may not be achieved in the planned time frame. Thus, the adjustment power amount is allocated to the preceding time frame in which a target value of the adjustment power amount is “0”. In the example of FIG. 6, the adjustment power amount of “80 kw” and the adjustment power amount of “160 kw” are allocated to the preceding time frames, that is, time frames “from 16:00 to 16:30” and “from 16:30 to 17:00”, respectively, of the resource 2.

FIG. 7 shows an example in which the adjustment plan information 2013A of FIG. 6 is visualized. The horizontal axis of the graph indicates the time. The vertical axis of the graph indicates the adjustment power amount. FIG. 7 shows that, there is crafted an adjustment plan in which the target adjustment value shown by the bold solid lines in FIG. 7 can be met while the constraint condition of each of the resources described in the operation constraint information 2110A is satisfied.

The value of the adjustment power amount of each time frame of all the resources obtained as the result of crafting the adjustment plan information 2013A is stored in a corresponding time frame in the tradable Quantity field 2012A7 of the transaction plan information 2012A.

FIG. 8 shows a configuration example of the resource specification information 2109A. The resource specification information 2109A is information indicating the specification of the resource participating in the adjustment of the power consumption, and is input in advance by a manager managing the resource operation management system 3, for example. When a computer operated by a home builder or the like provides information needed to generate a part of or all of the resource specification information 2109A, the resource specification information 2109A may be generated automatically or semi-automatically with use of that provided information.

The resource specification information 2109A manages, for each of the resources, a field 2109A1 for indicating the adjustment capacity, a field 2109A2 for indicating the change rate of the adjustment amount, a field 2109A3 for indicating the cost, a field 2109A4 for indicating the heat storage amount, and a field 2109A5 for indicating the heat amount change rate, for example.

The adjustment capacity field 2109A1 stores the maximum value and the minimum value of the power amount adjusted by the resource. The adjustment amount change rate field 2109A2 stores the Ramp-Up value and the Ramp-Down value, which are temporal change rates of the power adjustment by the resource.

The cost field 2109A3 stores the cost burdened by the power trader when the resource adjusts the power consumption. That cost is divided into the adjustment waiting fee and the adjustment implementation fee. The adjustment waiting fee is the cost paid to secure the resource, and is calculated as the cost of the adjustment power amount (kWh) per hour. The adjustment implementation fee is the cost of the adjustment power amount (kWh) when the adjustment of the power consumption is actually executed.

The heat storage amount field 2109A4 stores the maximum value and the minimum value of the heat amount that can be stored in the resource. The heat amount change rate field 2109A5 stores the heat consumption rate in the adjustment of the power consumption, and the inflow ratio and the outflow ratio of heat obtained regardless of whether the power consumption is adjusted or not. The resource specification information 2109A configured in this way is used when the adjustment plan crafting unit 2107 crafts the adjustment plan.

FIG. 9 shows a configuration example of the operation constraint information 2110A. The operation constraint information 2110A is information indicating the constraint on the operation of the resource, and is input in advance by the manager of the resource operation management system 3, for example. The consumer 4 may use the information input-output terminal 40 to input information on the operation constraint to the power transaction management system 1, or the power transaction management system 1 may obtain a part of or all of the information on the operation constraint from the control apparatus 41 of the consumer 4.

The operation constraint information 2110A includes, for example, a field 2110A1 for indicating the duration time in the execution of the adjustment, a field 2110A2 for indicating the duration time in the suspension of the adjustment, a field 2110A3 for indicating the temporal condition under which the adjustment is executable, and a field 2110A4 for indicating the exclusive condition of the time.

The adjustment execution duration time field 2110A1 stores the maximum value and the minimum value of the durable time in the execution of the adjustment for each of the resources. The adjustment suspension duration time field 2110A2 stores the maximum value and the minimum value of the time for which the adjustment is not executed, that is, the time for which the suspension is continued for each of the resources.

The adjustment executable time condition field 2110A3 stores, for each of the resources, the flag value for distinguishing between the time frame in which the adjustment can be made, and the time frame in which the adjustment cannot be made. The cross marks in FIG. 9 indicates the time frames in which the power consumption cannot be adjusted. The field 2110A4 of the exclusive condition of time stores the temporal exclusive condition for each of the resources. For example, there may be conditions that the power consumption can be adjusted only once a day due to the type, the characteristics, the features, and the like of the resource. The field 2110A4 stores the exclusive condition of the time frame, such as a condition under which the adjustment is not executed in the evening when the adjustment is executed in the morning, for example.

In the example of FIG. 9, when the “resource 1” starts the adjustment of the power consumption, the “resource 1” needs to continue the adjustment for at least “1.5” hours, and can only continue for “2” hours at most. When the “resource 1” ends the adjustment of the power consumption, the “resource 1” cannot resume the adjustment for at least “1” hour. The “resource 1” knows in advance that the power consumption cannot be adjusted in three successive time frames, that is, time frames “from 15:30 to 16:00”, “from 16:00 to 16:30”, and “from 16:30 to 17:00”, for example. The exclusive condition of time is configured in “resource 1”. That exclusive condition is a condition under which the time block of “from 17:00 to 20:00” and the time block of “from 09:00 to 12:00” compete against each other in terms of the execution of the power adjustment, and when power is adjusted in one of those time blocks, power cannot be adjusted in the other time block. The operation constraint information 2110A configured in this way is used when the adjustment plan crafting unit 2107 crafts the adjustment plan.

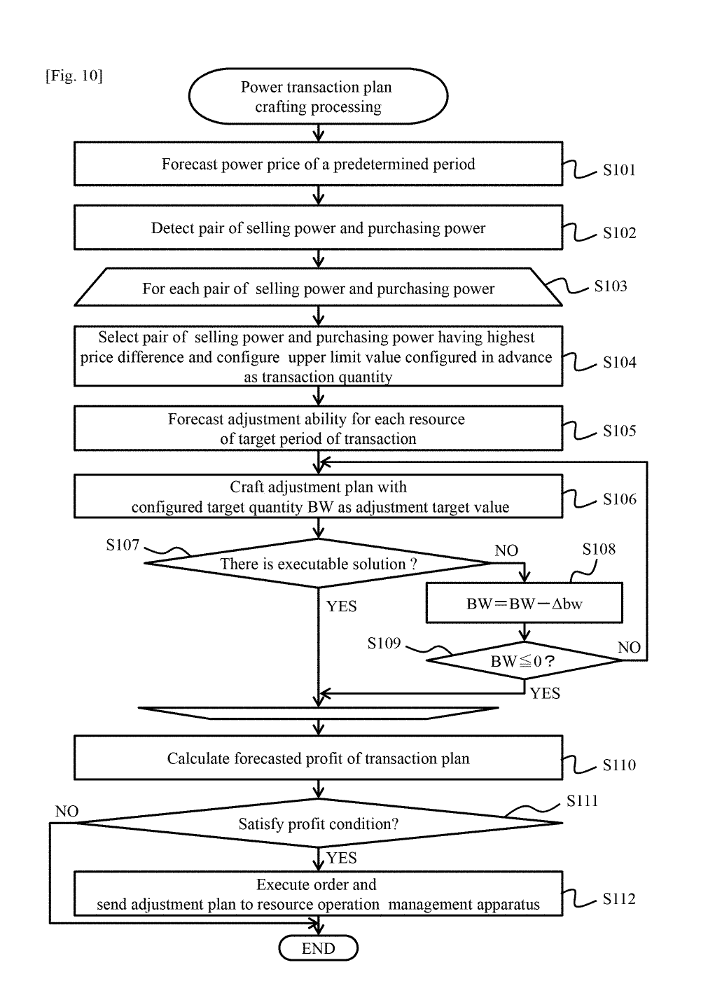

With reference to FIG. 10 to FIG. 14, the processing of the power transaction management system 1 is described. FIG. 10 is a flowchart illustrating the order of processing for crafting the power transaction plan. This processing is started when the power transaction management apparatus 20 accepts an input operation by the power trader.

First, the power transaction management apparatus 20 executes processing of from Step S101 to Step S104. Next, the resource availability evaluation apparatus 21 executes processing of from Step S105 to Step S107. Then, the power transaction management apparatus 20 finally executes processing of from Step S110 to Step S112.

When the determination result in Step S107 is “No”, the power transaction management apparatus 20 executes Step S108 and Step S109. Then, the resource availability evaluation apparatus 21 executes the processing of Step S106 and Step S107.

In practice, each of the processing is executed on the basis of various types of computer programs stored in the CPU 2001 and the storage apparatus 2005 of the power transaction management apparatus 20, or on the basis of various types of computer programs stored in the CPU 2101 and the storage apparatus 2105 of the resource availability evaluation apparatus 21. For the purpose of illustration, the processing entities are hereinafter described as the various types of computer programs that the power transaction management apparatus 20 and the resource availability evaluation apparatus 21 include.

First, the power price forecasting unit 2006 calculates the forecasted value of the power price for each of the power products in a predetermined future period on the basis of the past agreement result information 5001A obtained from the market operation management apparatus 50 (Step S101). For example, the power price forecasting unit 2006 forecasts the power price through a statistical approach using a multiple regression model in which explanatory variables are the date (month, day of week), the temperature, the crude oil price, and the like, or through signal processing using an AR (Auto-regressive) model or the like.

On the basis of the forecasted value of the price for each of the power products calculated in Step S101, and the threshold value of the price difference and the threshold value of the time difference configured by the transaction condition configuring unit 2007, the transaction plan crafting unit 2008 detects all the pairs of power products to be sold and purchased, which become the transaction candidates (Step S102). That is, the transaction plan crafting unit 2008 extracts all the pairs each formed of the power product that is of the target of sale and the power product that is the target of purchase. For example, on the basis of a threshold value “70 pound/Wh” of the price difference and a threshold value “3 hours” of the time difference configured by the transaction condition configuring unit 2007, the transaction plan crafting unit 2008 detects 12 types of pairs of power products in the transaction plan information 2012A shown in FIG. 5

The transaction plan crafting unit 2008 executes Step S104 to Step S107 or Step S104 to Step S109 described below for each of the pairs of power products detected as the candidates (Step S103).

On the basis of the priority degrees configured in advance, the transaction plan crafting unit 2008 selects the pair of power products to be traded among the pairs of power products of which transaction quantity is not determined yet, and configures the upper limit value of the transaction quantity as the transaction quantity (Step S104).

For example, when the priority degree of the pair of power products rises as the price difference of the pair of power products increases, the transaction plan crafting unit 2008 selects, out of the forecasted price difference field 2012A5 in the transaction plan information 2012A shown in FIG. 5, the pair of power products having a price difference of “87 pound/MWh ” as the target of transaction. This is because this pair of power products has the largest price difference, and the highest priority degree.

In this Embodiment, the total amount of the maximum values of the adjustment capacity for each of the resources described in the adjustment capacity field 2109A1 of the resource specification information 2019A is used as the upper limit value of the transaction quantity. In the example of FIG. 8, the total amount of the maximum adjustment capacity for the “resource 1” to the “resource 3” is 900 kW. Thus, the transaction plan crafting unit 2008 configures the transaction quantity of the pair of power products selected on the basis of the priority degrees to “900 kW”. That is, the maximum value of the adjustment power amount that can be sold with use of the resource under management of the power transaction management system 1 is used as an initial value of a transaction quantity BW.

The transaction plan crafting unit 2008 sets the target period of transaction as the implementing period of the adjustment plan. The transaction plan crafting unit 2008 sets the initial value of the transaction quantity configured in Step S104 as the target adjustment value in the delivery time frame of the selling power product. The transaction plan crafting unit 2008 sends the implementing period of the adjustment plan and the target adjustment value to the resource availability evaluation apparatus 21 (Step S104).

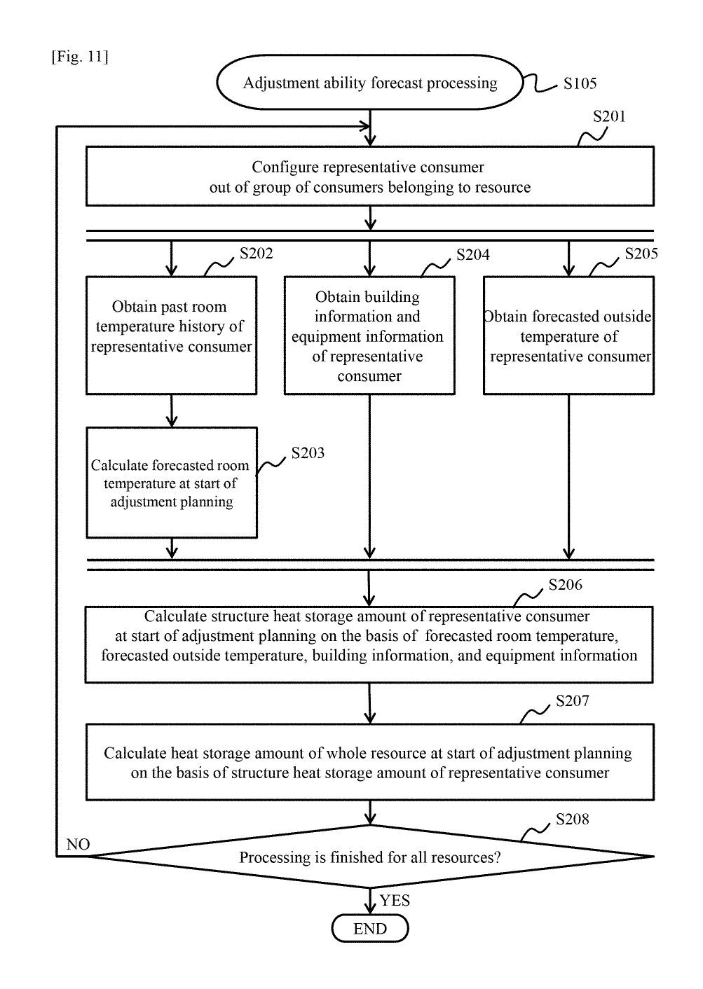

The adjusting ability forecasting unit 2106 forecasts the adjusting ability of the resource in the adjustment planning period sent from the power transaction management apparatus 20 (Step S105). The details of the processing by the adjusting ability forecasting unit 2106 are described later with reference to FIG. 11.

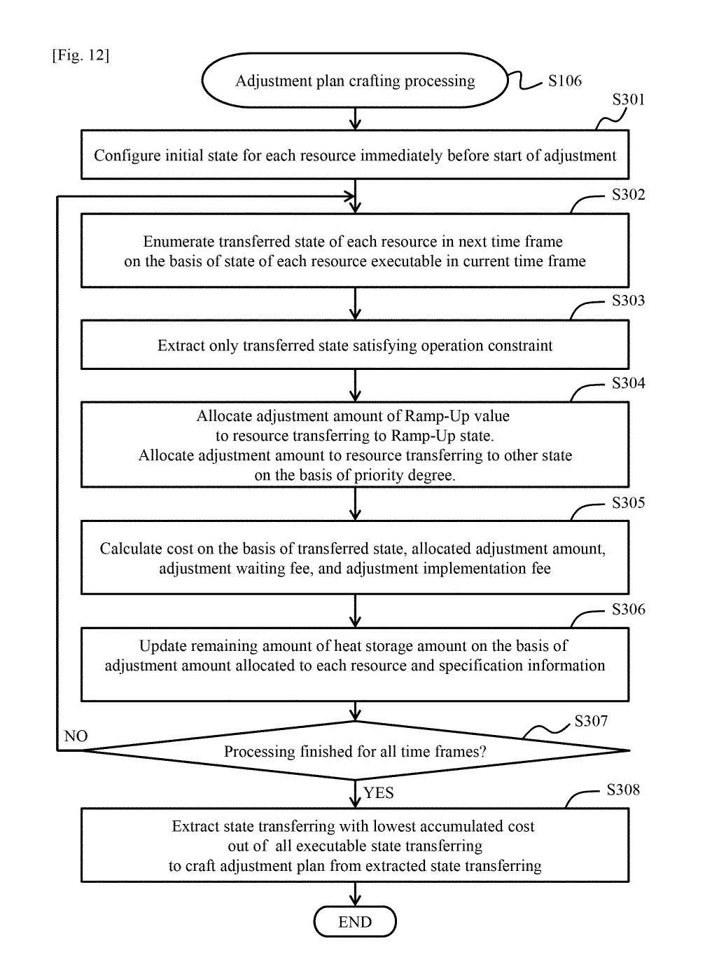

Next, on the basis of the adjusting ability of the resource forecasted by the adjusting ability forecasting unit 2106, the resource specification information 2109A, and the operation constraint information 2110A, the adjustment plan crafting unit 2107 crafts the adjustment plan for meeting the target adjustment value instructed by the power transaction management apparatus 20 (Step S106). When the adjustment plan crafting unit 2107 has been able to craft an executable adjustment plan (Step S107: YES), the adjustment plan crafting unit 2107 sends that adjustment plan to the power transaction management apparatus 20. When the adjustment plan crafting unit 2107 has not been able to craft an executable adjustment plan (Step S107: NO), the adjustment plan crafting unit 2107 sends a telegram message indicating to the effect to the power transaction management apparatus 20. The details of Step S106 performed by the adjustment plan crafting unit 2107 are described later with reference to FIG. 12.

When the power transaction management apparatus 20 receives the telegram message indicating that an executable adjustment plan cannot be crafted from the adjustment plan crafting unit 2107 (Step S107: NO), the power transaction management apparatus 20 reduces the transaction quantity BW, which becomes the target adjustment value, by a predetermined amount Δbw (Step S108). Then, the power transaction management apparatus 20 instructs the adjustment plan crafting unit 2107 again to craft the adjustment plan using the reduced transaction quantity as a new target adjustment value (Step S106). The power transaction management apparatus 20 reduces the transaction quantity BW, which becomes the target adjustment value, by the Predetermined amount Gbw at a time in Step S108 until the transaction quantity BW, which becomes the target adjustment value, is 0 (Step S109: YES).

After the adjustment plan is crafted by the adjustment plan crafting unit 2107, the profitability evaluating unit 2009 calculates the forecasted profit of the transaction plan on the basis of the forecasted price difference of the pair of power products, which is the target of transaction, and the calculation result of the cost in the adjustment plan crafted by the resource availability evaluation apparatus 21 (Step S110). The profitability evaluating unit 2009 determines whether the forecasted profit calculated in Step S110 satisfies the profit condition configured in advance (Step S111).

For example, the profitability evaluating unit 2009 executes a Monte Carlo simulation on the basis of a volatility such as the variance of the forecasted power price calculated by the power price forecasting unit 2006, and a volatility such as the variance of the adjusting ability of the resource calculated by the resource availability evaluation apparatus 21. The profitability evaluating unit 2009 determines whether a variance value of the forecasted profit obtained as a result of the Monte Carlo simulation, or an index value such as a VaR (Value at Risk) is equal to or smaller than a value configured in advance.

When it is determined that the transaction plan satisfies the profit condition (Step S111: YES), the order executing unit 2010 generates order data on the basis of the transaction plan information 2012A generated through Step S104 to Step S109, and sends the order data to the market operation management apparatus 50 (Step S112).

At the same time as the publishing of the order data, the order executing unit 2010 sends the adjustment plan to the resource operation management apparatus 30 on the basis of the adjustment plan information 2013A corresponding to the ordered transaction plan (Step S112), and the processing is ended.

FIG. 11 is a flowchart of the adjusting ability forecasting processing shown as Step S105 in FIG. 10. This processing is executed by the adjusting ability forecasting processing unit 2106 and the CPU 2101 when the information on the target period of the adjustment plan is received from the power transaction management apparatus 20. For the purpose of illustration, the processing entity is described as the adjusting ability forecasting unit 2106.

First, the adjusting ability forecasting unit 2106 configures the representative consumer out of the group of consumers that belongs to each of the resources (Step S201). The adjusting ability forecasting unit 2106 performs clustering based on statistical processing on the basis of attribute information describing the consumer such as the power demand profile, the location, the composition of the family, the building information, or the like, for example. The adjusting ability forecasting unit 2106 selects the consumer that is the closest to the average of the cluster as the representative consumer (Step S201).

Next, the adjusting ability forecasting unit 2106 obtains the measured room temperature history information of the past of the representative consumer from the measuring apparatus 42 of the representative consumer (Step S202), and then calculates the forecasted value of the room temperature at a time point that the adjustment planning period starts (Step S203). The forecasted value of the room temperature may be calculated through a statistical approach such as the multiple regression model, or through signal processing using the AR model or the like.

The adjusting ability forecasting unit 2106 obtains the building information and the equipment information of the representative consumer from the resource information management apparatus 31 (Step S204). The adjusting ability forecasting unit 2106 obtains, for example, information including the material and the thickness of the walls, the floor area, the number of windows and the orientation of the windows, and the like as the building information. The adjusting ability forecasting unit 2106 obtains, for example, information including the rated power consumption, the rated output, the COP (Coefficient of Performance), and the like of the equipment used in the adjustment of the power consumption as the equipment information.

The adjusting ability forecasting unit 2106 obtains the weather forecast information of the location of the representative consumer at a time point at which the planning of the adjustment is started from the weather information distributing apparatus 80 (Step S205). The weather forecast information may include the forecasted values of the outside air temperature, the humidity, the dew point, the amount of insolation, and the like, for example.

With use of the room temperature forecasted value (Step S203), the weather forecasted value (Step S205), and the building information and the equipment information (Step S204), the adjusting ability forecasting unit 2106 calculates the structure heat storage amount of the representative consumer at the time point at which the planning of the adjustment is started (Step S206). The structure heat storage amount may be calculated with use of a general heat transfer model.

On the basis of the structure heat storage amount of the representative consumer, the adjusting ability forecasting unit 2106 calculates the heat storage amount of the entire resource to which the representative consumer belongs (Step S207). The adjusting ability forecasting unit 2106 may forecast the heat storage amount of the entire resource from the structure heat storage amount of the representative consumer, for example, with use of the proportion of the power demand of the representative consumer to the power demand of the entire resource.

The adjusting ability forecasting unit 2106 determines whether the adjusting ability is forecasted for all the resources that are the processing targets (Step S208), and when there is a resource that is not processed yet (Step S208: NO), returns to Step S201 to repeat the steps described above.

FIG. 12 is a flowchart of the adjustment plan crafting processing described as Step S106 in FIG. 10. This processing is executed by the adjustment plan crafting unit 2107 and the CPU 2101 when the processing by the adjusting ability forecasting unit 2106 is ended, or when information on the period in which the adjustment plan is crafted is received from the power transaction management apparatus 20. For the purpose of illustration, the processing entity is described as the adjustment plan crafting unit 2107.

First, the adjustment plan crafting unit 2107 configures the initial state of each of the resources at the starting time point of the adjustment planning period (Step S301). The initial state to be configured is, for example, the state value indicating the execution state of the adjustment, the adjustment power amount in the execution of the adjustment, the duration time in which the adjustment is executed, the duration time in which the adjustment is not executed, and the heat storage amount of each of the resources calculated by the adjusting ability forecasting unit 2106.

Next, the adjustment plan crafting unit 2107 enumerates all the state values of the transferred states for each of the resources in the next time frame on the basis of the state value configured in Step S301 (the state value indicating the execution state of the adjustment) (Step S302). The adjustment plan crafting unit 2107 extracts, out of the enumerated state values, only the transferred states that can satisfy the constraint on each of the resources described in the operation constraint information 2110A while meeting the target adjustment value instructed by the power transaction management apparatus 20 (Step S303).

The adjustment plan crafting unit 2107 calculates an allocation value of the adjustment power amount for each of the resources on the basis of the transferred state in the next time frame (Step S304). The adjustment plan crafting unit 2107 may calculate the allocation value of the adjustment power amount by the same method as the method of dispatching the economic load on a power generator, for example. However, for the resource of which state is transferred to a state in which the state value of the adjustment is “2”, the Ramp-Up value of the resource is configured as the allocation value.

The adjustment plan crafting unit 2107 calculates the costs to be paid the power trader for the transferred state of each of the resources (Step S303), and the adjustment power amount allocated to each of the resources (Step S304) on the basis of the adjustment waiting fee and the adjustment implementation fee described in the resource specification information 2109A, respectively (Step S305).

On the basis of the heat amount change rate described in the resource specification information 2109A, the adjustment plan crafting unit 2107 calculates the heat storage amount of each of the resources in the next time frame from the adjustment power amount allocated to each of the resources calculated in Step S304 (Step S306).

The adjustment plan crafting unit 2107 implements the processing of from Step S302 to Step S306 for one time frame at a time until the adjustment planning period ends (Step S307: YES). The adjustment plan crafting unit 2107 extracts the sequence of state transferring having the lowest accumulated total cost as the adjustment plan (Step S308), and the processing is ended.

The adjustment plan crafting processing described above is generally known as dynamic programming. The dynamic programming is used to craft a power generation plan. However, the crafting of the adjustment plan in the adjustment power amount transaction according to this Embodiment is different from the crafting of the power generation plan in the following respects.

Firstly, the crafting of the adjustment plan is different from the crafting of the power generation plan in that the target adjustment value changes abruptly. The target adjustment value that is zero in a certain time frame rapidly increases to a large value in the next time frame. Secondly, the crafting of the adjustment plan is different from the crafting of the power generation plan in that the fluctuation rate of the adjustment power amount of the resource is extremely slow as compared to that of the power generator. Thus, in this Embodiment, the first and second differences described above are dealt by allocating the adjustment power amount in advance even to the time frame in which the target adjustment value is “0”, to thereby activate the resource. This characteristic processing of allocating the adjustment power amount in advance also to the time frame in which the target adjustment value is 0 is not performed in the crafting of the power generation plan. This characteristic processing may be described as below, for example. “The equipment information includes, as the equipment feature, the adjustment required time, which is the amount of time required for adjusting the power consumption of the equipment. The processing includes allocating, in advance, the predetermined adjustment power amount, which is smaller than the adjustment power amount required when the adjustment plan is executed, so that the adjustment power amount required when the adjustment plan is executed can be obtained in the adjustment required time before a time point at which the planning of the adjustment is started.”

The adjustment plan crafting processing of this Embodiment is a so-called combinatorial optimization processing, and hence approaches for efficiently obtaining the solution, for example, a genetic algorithm or the like may be applied thereto. In the combinatorial optimization processing, when the number of resources and the planning period increases, the number of combinations thereof is enormously increased, and hence the processing time is expanded. The expansion of the processing time can be suppressed, for example, by suppressing the number of the state transferring extracted in Step S303 to a certain number. In that case, the optimal combination may not be obtained, but a practical solution can be obtained in a relatively short time.

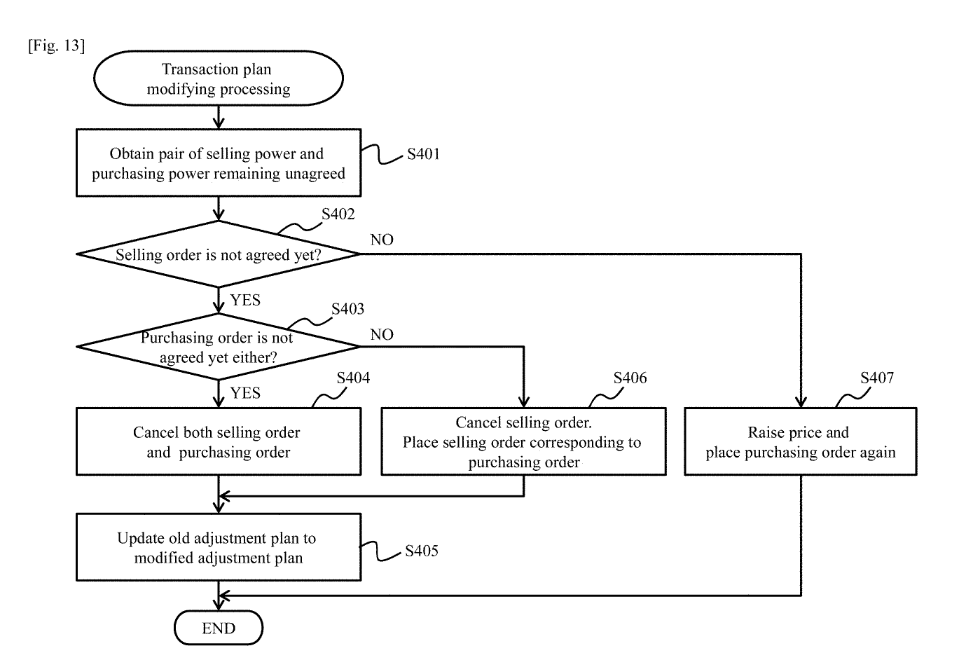

FIG. 13 is a flowchart of processing of modifying the transaction plan. This processing is executed on the basis of the transaction plan modifying unit 2011 and the CPU 2001 when the input operation by the transaction operation manager is accepted or each time a certain amount of time elapses, or when a modification time limit of the adjustment plan of the resource is reached. For the purpose of illustration, the processing entity is described as the transaction plan modifying unit 2011.

First, the transaction plan modifying unit 2011 detects an order that remains disagree (an order that is not agreed yet) at the time point at which this processing is started, out of the orders indicated by the order data sent to the market operation management apparatus 50 from the order executing unit 2010 (Step S401). As described above, the order is an order for the pair of power products, which is a target of purchase and sale.

The transaction plan modifying unit 2011 determines whether the order that is not agreed yet is a selling order or a purchasing order (Step S402 and Step S403). In this Embodiment, the transaction plan modifying unit 2011 first determines whether the order that is not agreed yet is a selling order (Step S402). That is, the transaction plan modifying unit 2011 determines whether the power product that is the target of sale is leftover among the pair of power products.

When the order that is not agreed yet is the selling order (Step S402: YES), the transaction plan modifying unit 2011 determines whether the purchasing order forming a pair with that selling order is also not agreed yet (Step S403). When both the selling order and the purchasing order are not agreed yet (Step S403: YES), the transaction plan modifying unit 2011 generates the order data for canceling those selling order and purchasing order that are not agreed yet, and sends the order data to the market operation management apparatus 50 (Step S404).

In other words, the transaction plan modifying unit 2011 generates the order data for cancelling the transaction quantity of both the selling order and the purchasing order by the amount of the adjustment power allocated to the resource of which plan modification time limit is reached, and sends the order data to the market operation management apparatus 50 through the order executing unit 2010. At the same time, the transaction plan modifying unit 2011 sends an identifier for determining the resource of which order is modified to the resource availability evaluation apparatus 21 (Step S404).

The adjustment plan modifying unit 2108 of the resource availability evaluation apparatus 21 receives the resource identifier from the power transaction management apparatus 20. The adjustment plan modifying unit 2108 discards the adjustment plan in the time frame in which the order is cancelled for the resource having the notified identifier (Step S405). Then, the adjustment plan modifying unit 2108 sends the modified adjustment plan to the power transaction management apparatus 20, to thereby update the adjustment plan information 2013A (Step S405).

When the selling order is not agreed yet (Step S402: YES), and the purchasing order corresponding to that selling order is agreed (Step S403: NO), the transaction plan modifying unit 2011 performs processing for the selling order that is not agreed yet as in Step S404 (Step S406). That is, the transaction plan modifying unit 2011 generates the order data for cancelling the transaction quantity by the amount of the adjustment power allocated to the resource of which plan modification time limit is reached, and sends the order data to the market operation management apparatus 50 through the order executing unit 2010. Through this processing, the selling order that is not agreed yet is cancelled.

Meanwhile, additional power secured by the agreed purchasing order becomes unnecessary by the amount of the adjustment power allocated to the resource of which plan modification time limit is reached. That is, the purchased additional power becomes unnecessary by the amount of the adjustment power amount that is leftover. The transaction plan modifying unit 2011 sells the unnecessary purchased power at the purchased price and by the purchased amount. That is, the transaction plan modifying unit 2011 generates the order data for placing the “selling order” for the time frame of the agreed purchasing order, at the price of the purchasing order and by the amount of the adjustment power amount allocated to the resource of which plan modification time limit is reached. Thus, the transaction plan modifying unit 2011 sends that order data to the market operation management apparatus 50 through the order executing unit 2010 (Step S406). Then, the transaction plan modifying unit 2011 performs the processing of Step S405 described above.

When the selling order is agreed (Step S402: NO), and the purchasing order is not agreed yet, power to be used in the advance preparation for adjusting the power consumption is not secured.

As described above, the power transaction management system 1 reduces and adjusts the power consumption of the resource in the time block in which the power demand is high, to thereby generate an adjustment power amount corresponding to the reduction in the power consumption, and sells that adjustment power amount to obtain the profit. In order to reduce the power consumption by the resource with little inconvenience as possible, the operating state of the equipment of the resource is controlled in advance.

For example, when the room is overcooled in advance using a cooling equipment of the resource before the outside air temperature raises and the power demand for cooling increases, not much inconvenience of life is caused even if the cooling equipment is suspended during the time block in which the outside air temperature is high. In the same manner, when the room is overheated in advance using a heating equipment of the resource before the outside air temperature declines and the power demand for heating increases, not much inconvenience of life is caused even if the heating equipment is suspended during the time block in which the outside air temperature is low. However, depending on the types of the cooling equipment and the heating equipment, it takes time to change from the suspended state to the steady operation state and to change from the steady operation state to the suspended state, and thus there is a need to distribute power to and operate the equipment in advance. As described above, such features of the equipment are considered in the power transaction management system 1 of this Embodiment.

As described above, when the purchasing order is not agreed yet, that is, when power to be used for the advance preparation is not secured, the additional power for the peak shifting in which overheating and overcooling are performed in advance is not secured. Therefore, the transaction plan modifying unit 2011 needs to secure power as soon as possible.

On the basis of the current indicative price, the transaction plan modifying unit 2011 raises the price of the power product that is ordered to be purchased to an agreeable price, and then sends the price to the market operation management apparatus 50 through the order executing unit 2010 (Step S407). In this case, the purchasing order is immediately agreed, and hence there is no need to modify the adjustment plan. Thus, Step S405 is skipped, and this processing is ended.

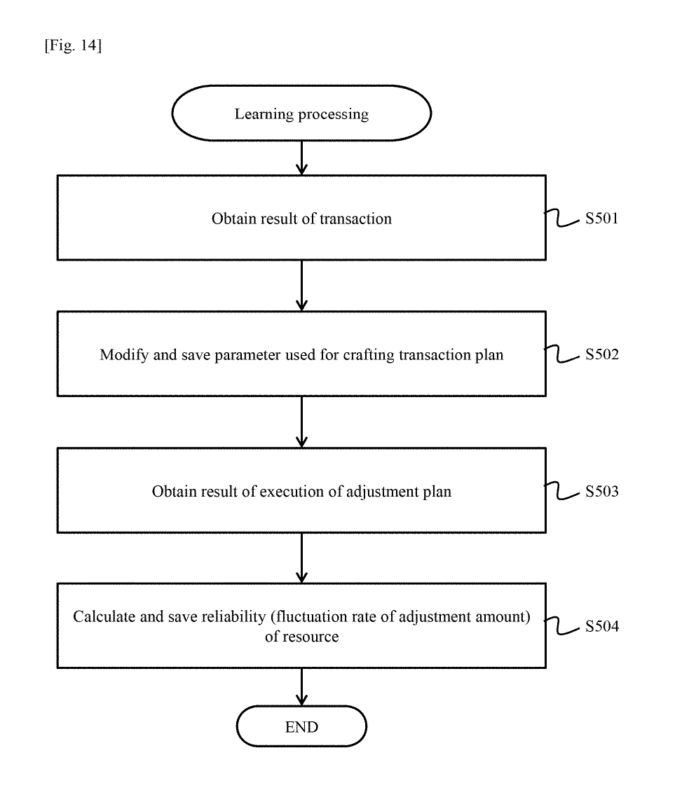

FIG. 14 is a flowchart for illustrating learning processing. This processing includes learning and improving a parameter used to create the transaction plan, and a parameter used to craft the adjustment plan.

The power transaction management apparatus 20 is the processing entity in the learning of the parameter relating to the transaction plan. The resource availability evaluation apparatus 21 is the processing entity in the learning of the parameter relating to the adjustment plan. Now, both of the learning of the parameter relating to the transaction plan and the learning of the parameter relating to the adjustment plan are described at the same time. Thus, the processing entity is described as the power transaction management system 1.

After the transaction is ended, the power transaction management system 1 obtains the result of the transaction from the power transaction management apparatus 20 (Step S501). On the basis of the result of the transaction, the power transaction management system 1 modifies and saves the parameter that is the target of modification among the parameters to be used to create the transaction plan (Step S502). The parameter that is the target of modification includes, for example, the threshold value of the price difference and the threshold value of the time difference used in Step S102 of FIG. 10. By dynamically changing the threshold value of the price difference and the threshold value of the time difference depending on the latest trend in the market, the latest weather forecast, or the like, the purchasing and selling orders through which the profit may be obtained can be efficiently agreed.

Further, the power transaction management system 1 obtains the result of executing the adjustment plan from the resource operation management apparatus 30 (Step S503). The power transaction management system 1 calculates and saves the reliability of each of the resources (Step S504). Even when the adjustment plan is sent to each of the resources at the same time as the publication of the order data, each of the resources may not always follow the received adjustment plan to adjust the power consumption. Further, the predetermined performance may not be delivered when the equipment that the resource owns is decrepit or is maintained poorly. Due to various reasons as above, the adjustment power amount that can be secured by the resource may be deviated from the target adjustment value. Thus, the power transaction management system 1 analyzes the result of execution of the adjustment plan, to calculate the fluctuation rate of the adjustment power amount, and uses the fluctuation rate in the devising of the next adjustment plan.

The power transaction management system 1 of this Embodiment configured in this way can achieve the adjustment amount transaction corresponding to the fluctuation in the power price by evaluating the temporal fluctuation in the adjusting ability of the resource in advance.

Through use of the information 5001A of the past agreement result obtained from the market operation management apparatus 50, the power transaction management system 1 detects the pair of the power products to be sold and purchased that is worth trading. Then, the power transaction management system 1 forecasts the adjusting ability of each of the resources in the delivery time block of the power product for which the selling order is placed among the detected pair of power products by calculating the forecast of the structure heat storage amount from a physical perspective based on the forecasted value of the temperature and the room temperature of the consumer representing the resource, and on the information on the building and the equipment of the consumer. The power transaction management system 1 generates the transaction plan information 2012A and the adjustment plan information 2013A by crafting the adjustment plan based on the adjusting ability forecasted for each of the resources, and the specification information 2109A and the operation constraint 2110A of the resource.

The power transaction management system 1 modifies the transaction plan information 2012A and the adjustment plan information 2013A with use of the current transaction state. As a result, in this Embodiment, the transaction of the adjustment power amount can be established in the market in which the power price fluctuates in consideration of the temporal fluctuation relating to the adjusting ability of the resources that the power trader groups.

This invention is not limited to Embodiments described above. Those skilled in the art may adopt various additions, modifications, and the like within the scope of this invention. For example, the time frame that is the target of transaction is not limited to being in units of 30 minutes, and may be in units of 1 hour, units of 2 hours, units of 3 hours, units of 4 hours, or the like. Further, for example, the power product may be a definite block such as a “peak on week days” power product or the like. Different types of block products may be also used as long as those products follow the transaction rules set by the power transaction market.

The power price forecasting unit 2006 and the adjusting ability forecasting unit 2106 are described as units each configured to calculate a forecast mainly on the basis of only the history information of the past, but this invention is not limited thereto. As described in FIG. 14, for example, the power price forecasting unit 2006 and the adjusting ability forecasting unit 2106 may perform learning using an accident error between the forecast result and the actual performance result obtained later.

A case in which the power price forecasting unit 2006 and the adjusting ability forecasting unit 2106 output the result of a point forecast are described, but this invention is not limited thereto, and information indicating volatilities such as variance, standard deviation, confidence interval, and the like, for example, may be output instead.

The information input to the transaction plan crafting unit 2008 is described as the forecasted value of the power price, but this invention is not limited thereto, and the information may be an indicative value of the wholesale price of the power product that is traded at the current time point, which can be obtained from the market operation management apparatus and for which the transaction ending time limit is not reached.

The output result of each of the processing units, and the interim results of each of the processing units may be output as appropriate through output apparatuses such as displays and printers.

### REFERENCE SIGNS LIST

1 Power transaction management system

4 Consumer

20 Power transaction management apparatus

21 Resource availability evaluation apparatus

30 Resource operation management apparatus

31 Resource information management apparatus

41 Control apparatus

42 Measuring apparatus

50 Market operation management apparatus

1. A power transaction management system managing a power transaction, comprising:
a communication unit communicatively coupled to a market operation management apparatus configured to manage a predetermined power transaction market, and to a plurality of consumers;
a memory unit configured to store a predetermined computer program; and
a processing unit coupled to the communication unit and the memory unit, and configured to execute the predetermined computer program thereby executing predetermined processing, wherein
the processing unit is configured to execute:
power price forecasting processing of forecasting a future power price in the predetermined power transaction market;
power product extracting processing of extracting information on a predetermined power product to be purchased and sold in the predetermined power transaction market on the basis of a predetermined power product extracting condition configured in advance and the forecasted power price;
adjusting ability forecasting processing of forecasting, for each of the consumers, a power consumption amount adjusting ability indicating an ability to adjust a power consumption amount at a predetermined time point of transaction of the predetermined power product;
adjustment plan crafting processing of crafting an adjustment plan by allocating a power amount to be traded of the predetermined power product to the each of the consumers on the basis of the power consumption amount adjusting ability;
transaction plan crafting processing of crafting a transaction plan for purchasing and selling the predetermined power product in the predetermined power transaction market on the basis of the adjustment plan;
ordering processing of sending order information based on the transaction plan to the market operation management apparatus; and
adjustment plan sending processing of sending the adjustment plan to the each of the consumers.

2. The power transaction management system according to claim 1, wherein
the processing unit is configured to execute, after the transaction plan crafting processing:
profit forecasting processing of forecasting a profit of the transaction plan; and
profitability determining processing of determining whether the forecasted profit satisfies a profit condition configured in advance, wherein
the ordering processing comprises sending the order information to the market operation management apparatus when determination is made that the forecasted profit satisfies the profit condition, and
the adjustment plan sending processing comprises sending the adjustment plan to the each of the consumers when the transaction plan is sent to the market operation management apparatus.

3. The power transaction management system according to claim 2, wherein the information on the predetermined power product comprises at least one of selling power product information for selling power in a time block in which a power demand is high or purchasing power product information for purchasing power in a time block in which a power demand is low, and wherein
a power price of the power product traded in the predetermined power transaction market continuously fluctuates.

4. The power transaction management system according to claim 3, wherein
the information on the predetermined power product comprises the selling power product information and the purchasing power product information corresponding to the selling power product information, and
the selling power product information and the purchasing power product information are traded in the predetermined power transaction market thereby shifting a power demand from the time block in which the power demand is high to the time block in which the power demand is low.

5. The power transaction management system according to claim 4, wherein
the processing unit is configured to further execute transaction plan modifying processing of modifying the transaction plan, and wherein
the transaction plan modifying processing comprises:
monitoring whether purchasing and selling of the predetermined power product are established in the predetermined power transaction market;
modifying the transaction plan when determination is made that the purchasing and selling of the predetermined power product are not established by a predetermined modification determination time point; and
modifying the adjustment plan on the basis of the modifying of the transaction plan.

6. The power transaction management system according to claim 5, wherein the processing unit is configured to further execute adjustment plan modifying processing of modifying the adjustment plan on the basis of the transaction plan modified through the transaction plan modifying processing.

7. The power transaction management system according to claim 6, wherein the predetermined power product extracting condition comprises a condition under which an amount of balance between a power price of the selling power product information and a power price of the purchasing power product information is equal to or larger than a predetermined price difference, and/or a condition under which a time of transaction of the selling power product information and a time of transaction of the purchasing power product information are separated from each other by a predetermined time difference or more.

8. The power transaction management system according to claim wherein the adjusting ability forecasting processing comprises:
forecasting, for a predetermined representative consumer selected out of the consumers, a representative heat storage amount, by which heat is storable in a building of the representative consumer, on the basis of room temperature history information, building information, equipment information, and outside air temperature information;
forecasting a whole heat storage amount, by which heat is storable by the consumers as a whole, on the basis of the representative heat storage amount; and
calculating, as the power consumption amount adjusting ability, an adjustable amount of power consumption of the consumers as a whole, on the basis of the whole heat storage amount.

9. The power transaction management system according to claim 8, wherein the adjustment plan crafting processing comprises allocating a power amount to be traded of the predetermined power product to the each of the consumers on the basis of the power consumption amount adjusting ability, a constraint condition configured in advance for the each of the consumers, and a feature of an equipment indicated in equipment information for the each of the consumers.

10. The power transaction management system according to claim 9, wherein the constraint condition comprises a condition on a time at which a power consumption amount is adjustable.

11. The power transaction management system according to claim 10, wherein the feature of the equipment comprises information on a control method for increasing or reducing a power consumption amount, a cost needed for adjusting a power consumption amount, and information on heat storage by the equipment.

12. The power transaction management system according to claim 11, wherein
the information on the control method comprises an adjustment required time, which is a time required for adjusting a power consumption amount of the equipment, and
the adjustment plan crafting processing comprises allocating a predetermined adjustment power amount, which is smaller than an adjustment power amount required in execution of the adjustment plan, in advance so that the adjustment power amount required in the execution of the adjustment plan is obtained in a preprocessing time that is earlier than start of the adjustment plan by the adjustment required time.

13. The power transaction management system according to claim 5, wherein the transaction plan modifying processing comprises:
modifying the transaction plan by raising a power price of the Purchasing power product information when purchasing and selling of the selling power product information are established and purchasing and selling of the purchasing power product information are not established;
cancelling the selling power product information and modifying the transaction plan to include new selling power product information including a power price and a power amount that are indicated in the Purchasing power product information, when purchasing and selling of the selling power product information are not established and purchasing and selling of the purchasing power product information are established; and
modifying the transaction plan so as to cancel both the selling power product information and the purchasing power product information when purchasing and selling of both the selling power product information and the purchasing power product information are not established.

14. A method of managing a power transaction with use of a power transaction management system,
the power transaction management system being communicatively coupled to a market operation management apparatus configured to manage a predetermined power transaction market, and to a plurality of consumers;
the method comprising, by the power transaction management system:
forecasting a future power price in the predetermined power transaction market;
extracting information on a predetermined power product to be purchased and sold in the predetermined power transaction market on the basis of a predetermined power product extracting condition configured in advance and the forecasted power price;
forecasting, for each of the consumers, a power consumption amount adjusting ability indicating an ability to adjust a power consumption amount at a predetermined time point of transaction of the predetermined power product;
crafting an adjustment plan by allocating a power amount to be traded of the predetermined power product to the each of the consumers on the basis of the power consumption amount adjusting ability;
crafting a transaction plan for purchasing and selling the predetermined power product in the predetermined power transaction market on the basis of the adjustment plan;
sending order information based on the transaction plan to the market operation management apparatus; and
sending the adjustment plan to the each of the consumers.
